(19) United States
(12) Patent Application Publication
(10) Pub. No.: US 2022/0383055 A1
(43) Pub. Date: Dec. 1, 2022

(54) INFORMATION PROCESSING APPARATUS AND INFORMATION PROCESSING METHOD

(71) Applicant: SONY GROUP CORPORATION, TOKYO (JP)

(72) Inventors: YOSHIYUKI KOBAYASHI, TOKYO (JP); CHISATO NUMAOKA, TOKYO (JP); MAKIKO YAMAMOTO, TOKYO (JP)

(21) Appl. No.: 17/755,583

(22) PCT Filed: Jul. 20, 2020
(86) PCT No.: PCT/JP2020/028176

§ 371 Date: May 2, 2022

(30) Foreign Application Priority Data
Nov. 8, 2019 (JP) 2019-203177

(51) Int. Cl. G06K 9/62

(52) U.S. Cl. CPC G06K 9/6289; G06K 9/6257; G06N 20/00

(57) ABSTRACT

Provided is an information processing apparatus that performs processing of sensor information using artificial intelligence. The information processing apparatus includes: a collection unit that collects first sensor information detected by a first sensor and second sensor information detected by a second sensor; a model generation unit that generates a learned model for estimating second sensor information corresponding to first sensor information on the basis of the first sensor information and the second sensor information that have been collected; an accumulation unit that accumulates the learned model; and a providing unit that provides a result of a service based on the learned model. The providing unit provides the learned model to the second apparatus in response to a request from the second apparatus.

### TECHNICAL FIELD

The technology disclosed in the present specification (hereinafter, “the present disclosure”) relates to an information processing apparatus and an information processing method using artificial intelligence.

### BACKGROUND ART

In recent years, various devices having a communication function incorporated therein have come into a state of being connected with each other via the Internet, and there is also a movement to collect data of sensors or the like handled by each device in a wide range and utilize the data for services of various industries.

Meanwhile, a technology for analyzing sensor data using artificial intelligence has also been developed. For example, an information processing apparatus that estimates distance information for an image acquired by an imaging apparatus using a learned model for estimating distance information from the image has been proposed (see Patent Document 1).

### CITATION LIST

### Patent Document

Patent Document 1: Japanese Patent Application Laid-Open No. 2019-124537

### SUMMARY OF THE INVENTION

### Problems to be Solved by the Invention

An object of the technology according to the present disclosure is to provide an information processing apparatus that performs processing of sensor information using artificial intelligence, and an information processing method.

### Solutions to Problems

A first aspect of the technology according to the present disclosure is

an information processing apparatus including:

a collection unit that collects first sensor information detected by a first sensor and second sensor information detected by a second sensor;

a model generation unit that generates a learned model for estimating second sensor information corresponding to first sensor information on the basis of the first sensor information and the second sensor information that have been collected;

an accumulation unit that accumulates the learned model; and

a providing unit that provides a result of a service based on the learned model.

The collection unit requests sensor information from a first apparatus including the first sensor or the second sensor, and collects the first sensor information or the second sensor information returned from the first apparatus.

The model generation unit generates a learned model for each combination of the first sensor and the second sensor, and the accumulation unit accumulates one or more learned models generated for each combination of the first sensor and the second sensor. Then, the providing unit selectively reads a learned model corresponding to a request from a second apparatus from the accumulation unit, and provides the learned model to the second apparatus as the result of the service. Alternatively, the providing unit estimates second sensor information corresponding to first sensor information transmitted from the second apparatus by using the learned model, and returns the estimated second sensor information as the result of the service.

Furthermore, a second aspect of the technology according to the present disclosure is

an information processing method including:

a collection step of collecting first sensor information detected by a first sensor and second sensor information detected by a second sensor;

a model generation step of generating a learned model for estimating second sensor information corresponding to first sensor information on the basis of the first sensor information and the second sensor information that have been collected;

an accumulation step of accumulating the learned model in an accumulation unit; and

a providing step of providing a result of a service based on the learned model.

Furthermore, a third aspect of the technology according to the present disclosure is

an information processing apparatus including:

a first sensor that detects first sensor information; and

an input unit that inputs, from a third apparatus, a result of a service based on a learned model for estimating second sensor information corresponding to first sensor information.

The input unit inputs, from a third apparatus, a learned model for estimating second sensor information corresponding to first sensor information as a result of the service. Furthermore, the information processing apparatus according to the third aspect further includes an estimation unit that estimates second sensor information corresponding to first sensor information detected by the first sensor by using the learned model that has been input.

Alternatively, the request unit transmits the first sensor information detected by the first sensor to a third apparatus, and the input unit inputs as the result of the service, from the third apparatus, second sensor information corresponding to first sensor information that has been transmitted, the second sensor information estimated using the learned model.

Furthermore, a fourth aspect of the technology according to the present disclosure is

an information processing method including steps of:

acquiring first sensor information from a first sensor;

requesting from a third apparatus a result of a service based on a learned model for estimating second sensor information corresponding to first sensor information; and

inputting the result of the service from the third apparatus.

Furthermore, a fifth aspect of the technology according to the present disclosure is

an information processing apparatus including:

a first sensor;

a collection unit that collects second sensor information detected by a second sensor; and

a model generation unit that generates a learned model for estimating second sensor information corresponding to first sensor information on the basis of first sensor information detected by the first sensor and the second sensor information collected by the collection unit.

The information processing apparatus according to the fifth aspect may further include an estimation unit that estimates second sensor information corresponding to first sensor information detected by the first sensor by using the learned model generated by the model generation unit. Furthermore, the information processing apparatus according to the fifth aspect may further include a providing unit that provides a fourth apparatus with a result of a service based on the learned model.

Furthermore, a sixth aspect of the technology according to the present disclosure is

an information processing method including:

a collection step of collecting second sensor information detected by a second sensor by an information processing apparatus; and

a model generation step of generating a learned model for estimating second sensor information corresponding to first sensor information on the basis of first sensor information detected by the first sensor in the information processing apparatus and the second sensor information collected in the collection step.

### Effects of the Invention

According to the technology according to the present disclosure, it is possible to provide an information processing apparatus that performs processing of sensor information using artificial intelligence, and an information processing method.

Note that the effects described in the present specification are merely examples, and the effects exhibited by the technology according to the present disclosure are not limited thereto. Furthermore, in addition to the effects described above, the technology according to the present disclosure may further exert additional effects.

Still other objects, features, and advantages of the technology according to the present disclosure will become apparent from a detailed description based on embodiments as described later and accompanying drawings.

### BRIEF DESCRIPTION OF DRAWINGS

FIG. 1 is a diagram illustrating a configuration example of an artificial intelligence sensor system to which the technology according to the present disclosure is applied.

FIG. 2 is a diagram illustrating an operation sequence example (first embodiment) of the artificial intelligence sensor system.

FIG. 3 is a diagram illustrating a functional configuration example (first embodiment) of a first apparatus 201.

FIG. 4 is a diagram illustrating a functional configuration example (first embodiment) of a third apparatus 203.

FIG. 5 is a diagram illustrating a mechanism in which a model generation unit 403 generates a learned model.

FIG. 6 is a diagram illustrating a functional configuration example (first embodiment) of a second apparatus 202.

FIG. 7 is a diagram illustrating an operation sequence example (second embodiment) of an artificial intelligence sensor system.

FIG. 8 is a diagram illustrating a functional configuration example (second embodiment) of a third apparatus 703.

FIG. 9 is a diagram illustrating a functional configuration example (second embodiment) of a second apparatus 702.

FIG. 10 is a flowchart illustrating a processing procedure for generating a learned model in a third apparatus 203.

FIG. 11 is a flowchart illustrating a processing procedure for returning second sensor information estimated in response to an estimation request in the third apparatus 703.

FIG. 12 is a diagram illustrating an operation sequence example (third embodiment) of the artificial intelligence sensor system.

FIG. 13 is a diagram illustrating a specific example (third embodiment) of the artificial intelligence sensor system.

FIG. 14 is a diagram illustrating a functional configuration example of a second apparatus 1202.

FIG. 15 is a diagram illustrating a mechanism in which a model generation unit 1405 generates a learned model.

FIG. 16 is a flowchart illustrating a processing procedure for generating a learned model in the second apparatus 1202.

FIG. 17 is a flowchart illustrating a processing procedure for performing estimation processing of sensor information in the second apparatus 1202.

FIG. 18 is a flowchart illustrating a processing procedure for providing the learned model to an external device by the second apparatus 1202.

FIG. 19 is a diagram illustrating a configuration example of a digital camera 1900.

FIG. 20 is a diagram illustrating a configuration example of a digital camera 2000.

FIG. 21 is a diagram illustrating an operation sequence example (fourth embodiment) of the artificial intelligence sensor system.

FIG. 22 is a diagram illustrating a mechanism in which a third apparatus 2103 acquires sensor information from two first apparatuses 2101-1 and 2101-2 and generates a learned model.

FIG. 23 is a diagram illustrating input and output data of a neural network according to a fourth embodiment.

### MODE FOR CARRYING OUT THE INVENTION

Hereinafter, embodiments of the technology according to the present disclosure will be described in detail with reference to the drawings.

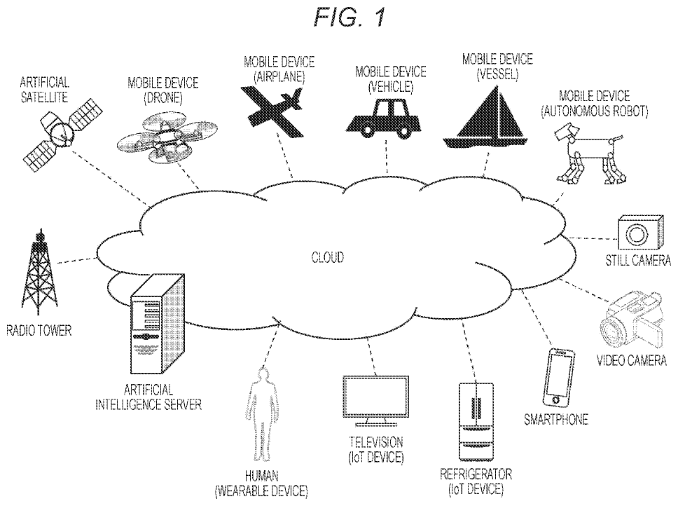

FIG. 1 schematically illustrates a configuration example of an artificial intelligence sensor system to which the technology according to the present disclosure is applied. The illustrated system includes an infinite number of sensor devices connected to a cloud.

The sensor devices referred to herein include various devices such as, in addition to an Internet of Things (IoT) device equipped with one or a plurality of sensor elements, an information device used by an individual person such as a digital camera, a smartphone, a tablet terminal, a personal computer (PC), and a digital camera, a fixed point observation device such as a security camera and a fixed point camera, a mobile device equipped with a plurality of sensors such as a camera and a radar such as an automobile and a drone, and an artificial satellite that captures the state of the ground surface and the temperature of the ground surface from above.

Furthermore, the cloud referred to herein generally refers to cloud computing, and provides a computing service via a network such as the Internet. In a case where computing is performed at a position closer to a served information processing apparatus in a network, the computing is also referred to as Edge Computing, Fog Computing, or the like. The cloud herein may be understood to refer to a network environment or a network system (resources for computing (including a processor, a memory, a wireless or wired network connection facility, and the like)) for cloud computing. Furthermore, the cloud may also be understood to refer to a service or a provider provided in the form of a cloud.

Furthermore, in the technology according to the present disclosure, it is assumed that there is also an artificial intelligence server that provides a function of artificial intelligence to a client on the Internet (alternatively, the cloud). The artificial intelligence is, for example, a function of artificially implementing, by software or hardware, a function exhibited by a human brain, such as learning, inference, data creation, and planning. The function of the artificial intelligence can be implemented using an artificial intelligence model represented by a neural network that simulates a human cranial nerve circuit.

The artificial intelligence model is a calculation model having variability used for artificial intelligence, which changes a model structure through learning (training) accompanied by an input of learning data. Regarding the neural network, in a case of using a brain-type (neuromorphic) computer, a node is also referred to as an artificial neuron via a synapse (or simply “neuron”). A neural network has a network structure formed by coupling between nodes (neurons), and is generally configured by an input layer, a hidden layer, and an output layer. The learning of the artificial intelligence model represented by the neural network is performed through processing of changing the neural network by inputting data (learning data) to the neural network and learning the degree of coupling between nodes (neurons) (hereinafter, also referred to as a “coupling weighting coefficient”). By using the learned artificial intelligence model (hereinafter, also referred to as a “learned model”), an optimal solution (output) to a problem (input) can be estimated.

Here, the neural network can have various algorithms, forms, and structures according to purposes, such as a convolutional neural network (CNN), a recurrent neural network (RNN), a generative adversarial network, a variational autoencoder, a self-organizing feature map, and a spiking neural network (SNN), and these can be arbitrarily combined.

The artificial intelligence server applied to the technology according to the present disclosure is assumed to be equipped with a multi-stage neural network capable of performing deep learning (DL). In a case where deep learning is performed, the number of pieces of learning data and the number of nodes (neurons) are large. Accordingly, it is considered appropriate to perform deep learning using huge computer resources such as a cloud.

The “artificial intelligence server” referred to herein is not limited to a single server apparatus, and may be, for example, a form of a cloud that provides a cloud computing service to a user via another device, and outputs and provides a service result (product) to another device.

Furthermore, the “client” (hereinafter, also referred to as a terminal, a sensor device, or an edge device) referred to herein is characterized by downloading at least a learned model generated by an artificial intelligence server from the artificial intelligence server as a result of a service by the artificial intelligence server, and performing processing such as inference and object detection using the downloaded learned model, or receiving sensor data inferred by the artificial intelligence server using the learned model as a result of a service and performing processing such as inference and object detection. The client may further include a learning function using a relatively small neural network so as to perform deep learning in cooperation with the artificial intelligence server.

Note that the above-described technology of the brain-type computer and other technologies of the artificial intelligence are not independent, and can be used in cooperation with each other. For example, a representative technology in a neuromorphic computer is SNN (described above). By using the SNN technology, for example, output data from an image sensor or the like can be used as data to be provided to an input of deep learning in a format of being differentiated on a time axis on the basis of an input data series. Therefore, in the present specification, unless otherwise specified, a neural network is treated as a type of artificial intelligence technology using a brain type computer technology.

Referring again to FIG. 1, there are various types of sensors mounted on a large number of sensor devices connected to a cloud. Various sensors can be roughly classified into a “general-purpose sensor” equipped in many sensor devices such as an RGB camera (alternatively, a camera that captures images of natural scenes), and a “specialized sensor” equipped in only some sensor devices for specific applications such as an infrared (IR) camera and a distance sensor. While general-purpose sensors have already become widespread all over the world, it is costly and time-consuming for specialized sensors to become so widespread.

For example, a terminal used by a general user is also one of the sensor devices, and by mounting an RGB photodiode, an image of a natural scene captured in an RGB image can be viewed through an application for an RGB photodiode. However, in a case where the terminal is not equipped with a distance measuring sensor such as an IR camera or Light Detecton And Ranging (LiDAR) or a depth sensor such as Time Of Flight (ToF), in general, an infrared image or a distance image cannot be viewed. If the terminal is equipped with a sensor other than the RGB photodiode, various sensor images other than images of natural scenes can be viewed, but this leads to an increase in apparatus cost. Furthermore, a situation in which information of an unmounted sensor is required after the user purchases the terminal is also assumed.

Furthermore, an information processing apparatus that estimates other sensor information from an image using a learned model has been proposed (see Patent Document 1). However, learning of a neural network requires enormous learning data, and a computation load is high. Therefore, it is unrealistic to learn a large-scale neural network in real time on a general terminal. Furthermore, in a case where it is desired to estimate two or more types of sensor information from an image on one terminal, a learned model is required for each type to be estimated.

Therefore, in the present specification, as a technology according to the present disclosure, a technology for performing generation processing of a learned model for estimating second sensor information sensed by a second sensor corresponding to first sensor information sensed by a first sensor on a third apparatus different from a terminal of a user, and providing a learned model, sensor information that is a result of inference using the learned model, or the like to the terminal of the user as a result of a service based on the learned model learned by the third apparatus will be proposed below. Here, the first sensor information is information originally output by an apparatus including the first sensor, and is sensor information used as learning data for generating a learned model in the technology according to the present disclosure. On the other hand, the second sensor information is information originally output by an apparatus including a second sensor, is information used as training data for generating the learned model in the technology according to the present disclosure, and is sensor information output as a result of inference by the apparatus including the first sensor using the learned model. Furthermore, it is assumed that the third apparatus is specifically implemented as a cloud or an artificial intelligence server on a cloud, but the third apparatus is not necessarily limited thereto.

Here, a relationship between the first sensor and the second sensor will be described on the basis of an example.

The first sensor in the present embodiment is, for example, a general-purpose sensor, and the second sensor is, for example, a specialized sensor, but is not necessarily limited to the combination. The first sensor may be a specialized sensor and the second sensor may be a general-purpose sensor. Alternatively, both the first sensor and the second sensor may be general-purpose sensors or both may be specialized sensors.

Specifically, examples thereof include a combination in which the first sensor is an RGB camera, and the second sensor is an IR sensor or a distance sensor. Alternatively, the first sensor may be an IR sensor or a distance sensor, and the second sensor may be an RGB camera.

Alternatively, the first sensor and the second sensor are not limited to different modalities, and it is also assumed that they are the same modality. For example, in a case where both the first sensor and the second sensor are RGB cameras, but manufacturers are different, a case where manufacturers are the same but models are different, and a case where performances (resolution, dynamic range, and the like) of the first sensor and the second sensor are different are also assumed. In such a case, the third apparatus performs generation of a learned model of performing estimation processing of an image captured by an RGB camera of a different manufacturer, estimation processing of an image captured by a new type RGB camera from an image captured by an old type RGB camera, estimation processing for up-converting a low resolution image or a low dynamic range image into a high resolution or high dynamic range image, and the like.

Furthermore, a combination in which the first sensor is a still camera (or a low frame rate camera) and the second sensor is a video camera (or a high frame rate camera) may be used. In such a case, the third apparatus performs generation of a learned model that performs estimation processing of interpolation frame for converting a still image (or a low frame rate image) into a moving image (or a high frame rate image) by frame interpolation.

Furthermore, the first sensor and the second sensor are not limited to sensors that capture two-dimensional information. For example, the first sensor may be an RGB camera, whereas the second sensor may be an IR sensor, a ranging sensor, a depth sensor, an audio sensor (such as a microphone), a temperature sensor, a vibration sensor, a wind sensor, a dynamic vision sensor (DVS), or the like. In such a case, the third apparatus generates a learned model for estimating distance, three-dimensional space, audio, temperature, vibration, wind, neuromorphic perception event, or the like from two-dimensional information such as images of natural scenes.

Note that, hereinafter, for convenience, a terminal of a user (corresponding to the sensor device in FIG. 1) that provides learning data to the third apparatus is referred to as a first apparatus, and a terminal of a user that receives provision of a result of a service related to a learned model learned by the third apparatus will be referred to as a second apparatus. In some cases, the second apparatus may behave as a first apparatus that provides learning data to the second apparatus.

### First Embodiment

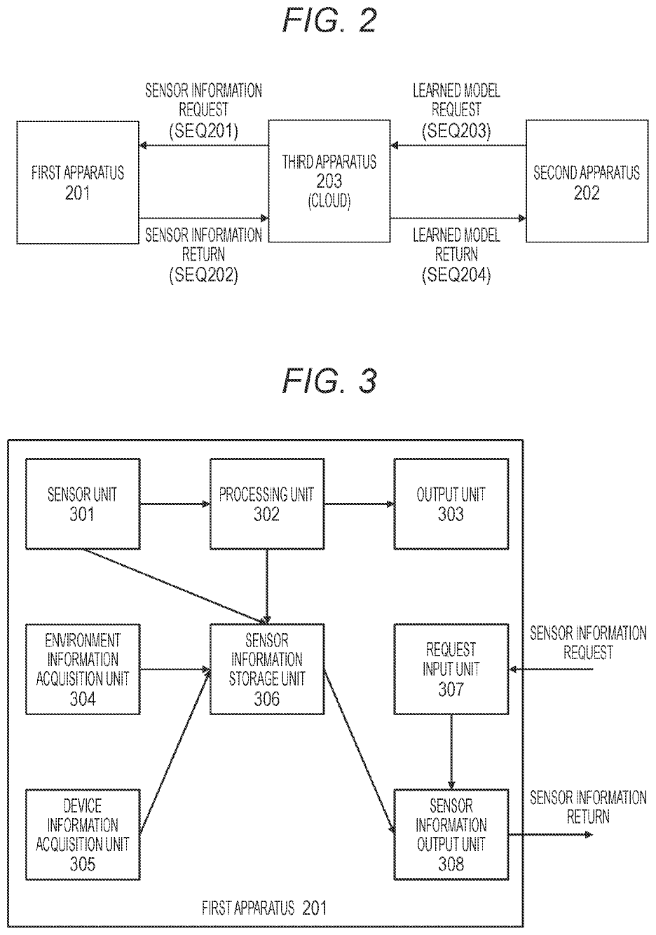

FIG. 2 illustrates an operation sequence example of an artificial intelligence sensor system according to a first embodiment. In reality, the artificial intelligence sensor system has the configuration illustrated in FIG. 1, but in FIG. 2, for simplification, the artificial intelligence sensor system includes a first apparatus 201 that provides sensor information as learning data, a third apparatus 203 that learns a model on the basis of the sensor information provided from the first apparatus 201 and generates a learned model, and a second apparatus 202 to which a result of a service using the learned model is provided from the third apparatus 203. In the first embodiment, the result of the service is a learned model requested by the second apparatus 202. The third apparatus 203 provides the learned model corresponding to the request of the second apparatus 202 as the result of the service.

The first apparatus 201 may be a terminal of a user such as a smartphone, a tablet, a PC, or a digital camera, a fixed point observation device such as an IoT device, a security camera, or a fixed point camera, a mobile device, an artificial satellite, or the like. Furthermore, the second apparatus 202 is assumed to be a terminal of the user such as a smartphone, a tablet, a PC, or a digital camera. Furthermore, the third apparatus 203 is configured by, for example, an artificial intelligence server (described above) installed on a cloud, on the assumption that deep learning is performed with a large number of pieces of learning data and a large number of nodes (neurons). The third apparatus also operates as a learned model providing server that returns a learned model in response to a learned model request from the outside. It is assumed that the first apparatus 201 and the third apparatus 203 and the third apparatus 203 and the second apparatus 202 are interconnected via a network such as the Internet. However, the form of connection is not particularly limited.

The first apparatus 201 includes at least one of a first sensor or a second sensor, and provides sensor information as learning data to the third apparatus 203. Although only one first apparatus 201 is illustrated in FIG. 2 for simplification, it is assumed that an infinite number of first apparatuses each including a first sensor and providing first sensor information as learning data and an infinite number of first apparatuses each including a second sensor and providing second sensor information as training data exist.

The third apparatus 203 generates a learned model for estimating sensor information. For convenience of description, it is assumed that the third apparatus 203 generates a learned model for estimating second sensor information corresponding to first sensor information. Furthermore, the third apparatus 203 provides the second apparatus 202 with a learned model for estimating second sensor information corresponding to first sensor information as a result of the service based on the learned model.

Then, the second apparatus 202 is equipped with the first sensor (not equipped with the second sensor), and can use the second sensor information corresponding to first sensor information sensed by the first sensor in response to the provision of the result of the service related to the learned model generated by the third apparatus 203. Although only one second apparatus 202 is illustrated in FIG. 2 for simplification, there may be a plurality of second apparatuses to which a learned model is provided as a result of a service based on the learned model from the third apparatus 203.

Note that the relationship between the first sensor and the second sensor is basically in accordance with the above description, and a detailed description thereof will be omitted here.

Referring to FIG. 2, the third apparatus 203 requests sensor information from the first apparatus 201 (SEQ 201). On the other hand, the first apparatus 201 returns the first sensor information in a case of being equipped with the first sensor, and returns the second sensor information in a case of being equipped with the second sensor (SEQ 202).

The third apparatus 203 may perform the sensor information request in SEQ 201 in any format such as unicast communication or multicast communication addressed to a specific address or broadcast communication addressed to an unspecified address. Furthermore, the sensor information request may include meta-information designating desired sensor information, such as a type of sensor to be requested (whether the sensor is the first sensor or the second sensor), specification information of the sensor (manufacturer name, model, performance (resolution, frame rate), or the like), and a sensing environment (place, date, and time, weather, and the like where the sensor information is acquired).

Of course, in SEQ 201, the third apparatus 203 may transmit a request for the sensor information without particularly designating the sensor information, collect the sensor information from more first apparatuses 201, and then select or classify the sensor information collected in the third apparatus 203. The sensor information is preferably managed in the database so as to be searchable by the meta-information. The data stored in the database may be divided in units of blocks using a blockchain technology, and may be distributedly managed by adding hash data.

On the other hand, in a case where the sensor information request received in SEQ 201 is not addressed to the address of the first apparatus 201, the first apparatus 201 may discard this request and may not return the sensor information. Furthermore, in a case where the first apparatus 201 receives the sensor information request addressed to the first apparatus 201 or the sensor information request multicast or broadcast and the request includes meta-information designating the sensor information, the first apparatus 201 may return only the sensor information satisfying the condition designated by the meta-information in SEQ 202. Furthermore, in SEQ 202, the first apparatus 201 may return the sensor information by attaching, to the sensor information, meta-information indicating a type of sensor (whether the sensor is the first sensor or the second sensor), specification information of the sensor (manufacturer name, model, performance (resolution, frame rate), or the like), a sensing environment (place, date, and time, weather, and the like where the sensor information is acquired) or the like.

Note that, in the operation sequence example illustrated in FIG. 2, the first apparatus 201 returns the sensor information on the basis of the request from the third apparatus 203, but the sensor information may be autonomously transmitted to the third apparatus 203 regardless of the presence or absence of the request. For example, the first apparatus 201 may transmit the sensor information to the third apparatus 203 every predetermined period, or when the sensor information changes due to elapse of time, movement of an installation place of the apparatus, or the like.

The third apparatus 203 collects an enormous amount of pieces of first sensor information and second sensor information as learning data according to a sequence of sensor information requests (SEQ 201) and sensor information returns (SEQ 202) with an infinite number of first apparatuses 201. Then, the third apparatus 203 performs generation processing of a learned model for estimating second sensor information corresponding to first sensor information using the sensor information collected from the first apparatus 201 as learning data. Here, the learned model is an artificial intelligence model. In the present embodiment, the artificial intelligence model is represented by a neural network formed by coupling between nodes (neurons). Then, the learned model can be generated by inputting learning data to the neural network and changing the coupling weighting coefficient between nodes (neurons) by learning (training). The third apparatus 203 accumulates the generated learned model.

The third apparatus 203 collects an enormous amount of learning data by continuously performing a sequence of a sensor information request (SEQ 201) and a sensor information return (SEQ 202), and appropriately performs relearning of a learned model to generate and hold a latest learned model.

The second apparatus 202 is equipped with a first sensor but not with a second sensor. The third apparatus 203 provides the learned model to the second apparatus 202. Accordingly, the second apparatus 202 can utilize the provided learned model to estimate second sensor information corresponding to first sensor information sensed by the first sensor, and can also utilize the second sensor information even without the second sensor being equipped.

Referring again to FIG. 2, the second apparatus 202 requests a learned model from the third apparatus 201 (SEQ 203). In response to this, the third apparatus 203 returns the requested learned model to the second apparatus 202 (SEQ 204). Therefore, the second apparatus 202 may acquire the latest learned model from the third apparatus 203 at any time through a sequence of the learned model request (SEQ 203) and the learned model return (SEQ 204) with the third apparatus 203.

When the second apparatus 202 requests the learned model, the second apparatus 202 may include meta-information designating the type and sensor specification information of the first sensor mounted on the second apparatus 202, and further designating the type and specification information of the desired second sensor. In such a case, it is sufficient that the third apparatus 203 returns the learned model suitable for the combination of the first sensor and the second sensor designated by the second apparatus 202 by the meta-information to the second apparatus 202.

Here, the learned model is represented by a neural network, and data (hereinafter, also referred to as “learned model data”) representing the learned model includes a set of nodes (neurons) and a set of coupling weighting coefficients between the nodes (neurons) in the neural network. In SEQ 204, the third apparatus 203 may compress the bit stream of the learned model data and transmit the compressed bit stream to the second apparatus 202. Furthermore, when the size of the bit stream is large even after compression, the learned model data may be divided into a plurality of pieces, and the compressed bit stream may be downloaded a plurality of times. When the learned model data is divided, the learned model data may be divided for each layer of the network or for each region in the layer.

Note that the second apparatus 202 transmits, to the third apparatus 203, a request for a learned model for estimating the second sensor information from the first sensor information in response to generation of a request for use of the second sensor information corresponding to first sensor information from an application operating on the second apparatus that handles the first sensor information, for example. Regarding the request for use of the second sensor information, in the application operating on the second apparatus 202, the request for the learned model may be transmitted to the third apparatus 203 in response to an instruction to convert the sensor information or the like from a user who operates the second apparatus 202 via a user interface or the like. Furthermore, the second apparatus 202 may convert the sensor information in the application operating on the second apparatus 202, infer the aspect to be presented to the user, and transmit the request for the learned model to the third apparatus 203 according to the inference result. In this case, the second apparatus 202 may be equipped with artificial intelligence used for the inference of the aspect, and transmit the request of the learned model to the third apparatus 203 on the basis of the inference result by the artificial intelligence. Alternatively, instead of returning the learned model on the basis of the request from the second apparatus 202, the third apparatus 203 may search for the second apparatus 202 to which the learned model is to be provided by itself on the basis of inference or the like and performs push distribution of the latest learned model.

Then, the second apparatus 202 uses the latest learned model received from the third apparatus 203 to perform processing of estimating, from the first sensor information sensed by the first sensor in the second apparatus 202, the second sensor information assumed to be sensed in a case where the second sensor is mounted in the second apparatus 202.

FIG. 3 schematically illustrates a functional configuration example of the first apparatus 201. The illustrated first apparatus 201 includes a sensor unit 301, a processing unit 302, an output unit 303, an environment information acquisition unit 304, a device information acquisition unit 305, a sensor information storage unit 306, a request input unit 307, and a sensor information output unit 308. Note that each of the components 302 to 308 is implemented by executing a program on a processor such as a central processing unit (CPU), a graphics processing unit (GPU), or a general-purpose computing on GPUs (GPGPU), or by a combination of an execution program and a hardware component in first apparatus 201.

In a case where the sensor unit 301 is one or more sensor elements (complementary metal oxyde semiconductor (CMOS) image sensor including at least one of a first sensor or a second sensor, the sensor unit 301 includes an analog-to-digital conversion (ADC) processing circuit and the like. The processing unit 302 performs signal processing of sensor information sensed by the sensor unit 301. For example, in a case where the sensor unit 301 is a CMOS image sensor and includes an RGB camera, the processing unit 302 performs conversion processing (for example, processing of converting RAW data into JPEG or TIFF format) of an image signal output from the RGB camera.

The output unit 303 includes an application that processes the sensor information after the signal processing in the processing unit 302. For example, in a case where the sensor unit 301 includes an RGB camera, the output unit 303 can include a camera application that performs digital image recording on the basis of RGB digital data that is sensor information processed and output by the processing unit 302. Furthermore, the output unit 303 may include a device such as a liquid crystal display that presents the sensor information to the user.

The environment information acquisition unit 304 has a function of acquiring a sensing environment such as a place, a date and time, and weather when the sensor unit 301 acquires sensor information. The environment information acquisition unit 304 may include, for example, a sensor such as a global positioning system (GPS), an inertial measurement unit (IMU), a clock, a thermometer, or a hygrometer. Furthermore, the environment information acquisition unit 304 may acquire information of some sensing environments such as weather and time from the outside via a network.

The device information acquisition unit 305 has a function of acquiring device information of the first apparatus 201 itself including specification information (manufacturer name, model, performance (resolution, frame rate) or the like) regarding the first sensor or the second sensor equipped in the sensor unit 301. The device information acquisition unit 305 may include a read only memory (ROM) that stores device information, and may appropriately read necessary device information from the ROM.

The sensor information storage unit 306 stores sensor information (RAW data) sensed by a sensor included in the sensor unit 301 or sensor information (for example, JPEG data or TIFF data) after predetermined signal processing is performed by the processing unit 302. In the present embodiment, since it is assumed that the sensor unit 301 includes at least one of the first sensor or the second sensor, the sensor information storage unit 306 stores at least one of the first sensor information from the first sensor or the second sensor information from the second sensor. Furthermore, the sensor information storage unit 306 may store the sensor information in association with the type of the sensor, the specification information of the sensor, and the sensing information supplied from each of the environment information acquisition unit 304 and the device information acquisition unit 305.

The request input unit 307 inputs a sensor information request from the third apparatus 203. Then, in response to the sensor information request, the sensor information output unit 308 reads the first sensor information or the second sensor information from the sensor information storage unit 306, and returns the first sensor information or the second sensor information to the third apparatus 203.

However, in a case where the input sensor information request is not addressed to the address of the first apparatus 201, the request input unit 307 discards the sensor information request. Furthermore, in a case where the sensor information request input by the request input unit 307 is attached with the meta-information designating the sensor type and the sensor specification, the sensor information output unit 308 reads the sensor information satisfying the condition designated by the meta-information from the sensor information storage unit 306 and returns the sensor information to the third apparatus 203. Note that, in a case where the sensor information satisfying the condition designated by the meta-information is not stored in the sensor information storage unit 306, the sensor information output unit 308 may return the sensor information matching or approximating the designated condition to the third apparatus 203 or discard the sensor information request. Furthermore, the sensor information output unit 308 may attach meta-information indicating the type of sensor, the specification information of the sensor, and the sensing environment, and return the sensor information.

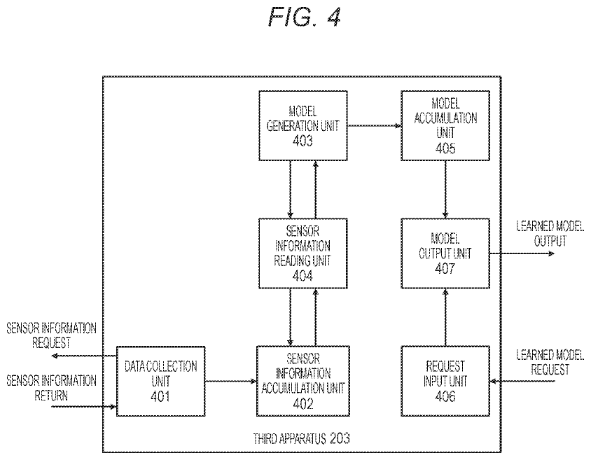

FIG. 4 schematically illustrates a functional configuration example of the third apparatus 203. The illustrated third apparatus 203 includes a data collection unit 401, a sensor information accumulation unit 402, a model generation unit 403 that generates a learned model, a sensor information reading unit 404, a model accumulation unit 405 that accumulates the learned model, a request input unit 406, and a model output unit 407 that outputs the learned model. Note that each of the components 401 to 407 is implemented by executing a program on a processor such as a CPU, a GPU, or a GPGPU, or by a combination of the execution program and a hardware component in the third apparatus 203.

The data collection unit 401 performs processing of generating a learned model and collecting learning data to be used for relearning. Specifically, the data collection unit 401 transmits a sensor information request to an infinite number of first apparatuses 201, receives the first sensor information or the second sensor information returned from each of the first apparatuses 201, and stores the first sensor information or the second sensor information in the sensor information accumulation unit 402 as learning data. The sensor information request to be transmitted to first apparatus 201 may be attached with meta-information designating a sensor type or a sensor specification.

However, it is also assumed that the sensor information is regularly or irregularly pushed from the first apparatus 201 without the sensor information request transmitted, but in this case as well, the data collection unit 401 performs reception processing and stores the sensor information in the sensor information accumulation unit 402.

Furthermore, the sensor information transmitted from the first apparatus 201 may be attached with meta-information indicating the type of sensor, the specification information of the sensor, and the sensing environment. The data collection unit 401 stores the sensor information collected from the first apparatus 201 in the sensor information accumulation unit 402 in association with the type of the sensor, the specification information of the sensor, and the sensing environment.

The sensor information reading unit 404 reads the first sensor information and the second sensor information to be the learning data from the sensor information accumulation unit 402, and supplies the first sensor information and the second sensor information to the model generation unit 403. However, when reading the sensor information, the sensor information reading unit 404 pairs a combination of the first sensor information and the second sensor information in which the sensing environments match or approximate to each other, reads the combination from the sensor information accumulation unit 402, and supplies the combination to the model generation unit 403. This is because the second sensor information having matching or approximate sensing environment is suitable as the training data (described later).

The model generation unit 403 performs learning of artificial intelligence for performing processing of estimating second sensor information corresponding to first sensor information by using as learning data the sensor information received from the sensor information reading unit 404. Here, it is assumed that the artificial intelligence uses a learned model represented by a neural network. Then, the model generation unit 403 generates, as a learned model, a neural network including a coupling weighting coefficient between nodes (neurons) capable of estimating second sensor information corresponding to first sensor information while changing the coupling weighting coefficient between the nodes (neurons), and stores the neural network in the model accumulation unit 405.

Note that the first sensor and the second sensor may be further finely classified for each specification or performance. Therefore, the model generation unit 403 may generate a learned model for each combination of specifications and performance. In this case, the sensor information reading unit 404 reads the first sensor information and the second sensor information corresponding to the specification and performance to be subjected to model generation, and the model generation unit 403 generates the learned model for each combination of the specification and the performance. Then, the model accumulation unit 405 accumulates a learned model for each combination of specifications and performance.

The request input unit 406 inputs the request for the learned model from the second apparatus 202. Then, the model output unit 407 selectively reads the learned model corresponding to the request of the learned model from the model accumulation unit 405, and returns the learned model to the second apparatus 202.

The request for the learned model from the second apparatus 202 may include the meta-information designating the type and sensor specification information of the first sensor mounted on the second apparatus 202, and the type and specification information of the desired second sensor. In such a case, it is sufficient that the model output unit 407 selectively reads the learned model suitable for the combination of the first sensor and the second sensor designated by the second apparatus 202 from the model accumulation unit 405 and returns the learned model to the second apparatus 202 as the request source.

Furthermore, the model output unit 407 may compress the bit stream of the learned model data and transmit the compressed bit stream to the second apparatus 202. Furthermore, when the size of the bit stream is large even after compression, the learned model data may be divided into a plurality of pieces, and the compressed bit stream may be transmitted a plurality of times. When the learned model data is divided, the learned model data may be divided for each layer of the network or for each region in the layer.

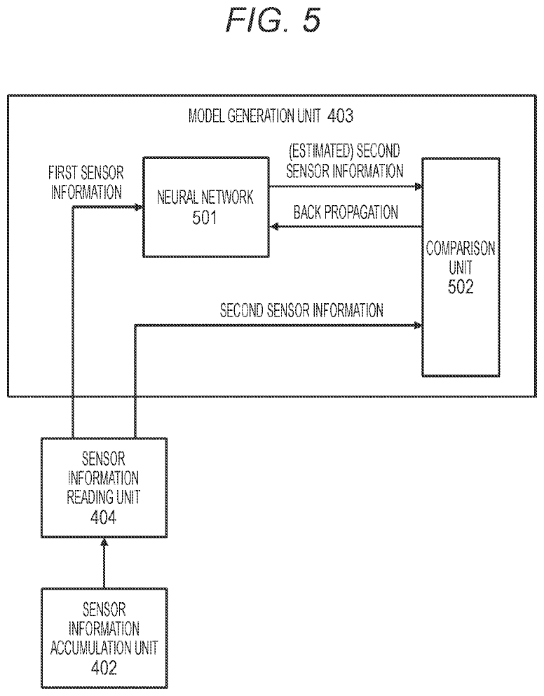

FIG. 5 illustrates a mechanism in which the model generation unit 403 generates a learned model.

The model generation unit 403 includes a neural network 501 as an artificial intelligence model. By inputting the first sensor information and the second sensor information to the neural network 501 and performs learning of the artificial intelligence model, the neural network 501 including a coupling weighting coefficient between nodes (neurons) is generated as a learned model capable of estimating second sensor information corresponding to first sensor information. Furthermore, the model generation unit 403 further includes a comparison unit 502 that compares the output of the neural network 501 with the training data. The neural network 501 including the learned coupling weighting coefficient is stored in the model accumulation unit 405 as a learned model generated by the model generation unit 403.

Furthermore, the sensor information reading unit 404 pairs and reads the first sensor information and the second sensor information from the sensor information accumulation unit 402, and supplies the first sensor information and the second sensor information to the model generation unit 403. When reading the sensor information, the sensor information reading unit 404 pairs a combination of the first sensor information and the second sensor information in which the sensing environments match or approximate to each other, reads the combination from the sensor information accumulation unit 402, and supplies the combination to the model generation unit 403. For example, in a case where the first sensor information is an RGB image and the second sensor information is an IR image, an IR image captured in the same place (or of the same subject) in a situation where date and time, weather, and the like are more similar is suitable as training data for evaluating an IR image estimated from the RGB image. From such a viewpoint, the sensor information reading unit 404 performs reading from the sensor information accumulation unit 402 by pairing the second sensor information serving as the training data with the first sensor information.

The neural network 501 estimates the second sensor information from the first sensor information supplied from the sensor information reading unit 404. Then, the comparison unit 502 compares the second sensor information estimated by the neural network 501 with the second sensor information read by the sensor information reading unit 404 in combination with the first sensor information. That is, the second sensor information paired with the first sensor information is used as training data, and a loss function based on a difference between the training data and the second sensor information estimated by the neural network 501 is defined. Then, the learning of the neural network 501 is performed by back propagation so as to minimize the loss function. The neural network 501 including the learned coupling weighting coefficient between nodes (neurons) is stored in the model accumulation unit 405 (not illustrated in FIG. 5) as a learned model generated by the model generation unit 403.

Note that, in a case where it is assumed that the third apparatus 203 is installed as a server on a cloud, all the functional components 401 to 407 illustrated in FIG. 4 are not necessarily implemented in a single server apparatus. For example, it is also assumed that a function of collecting and accumulating learning data and a function of generating a learned model using the accumulated learning data are arranged on different server apparatuses.

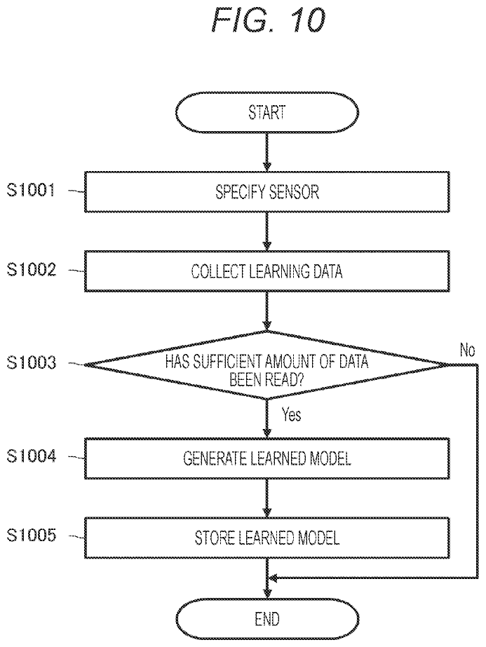

FIG. 10 illustrates a processing procedure for generating the learned model in the third apparatus 203 in the form of flowchart. It is assumed that the third apparatus 203 collects a large amount of learning data from a large number of first apparatuses 201 in advance and accumulates the learning data in the sensor information accumulation unit 402 before starting this processing procedure.

First, the model generation unit 403 specifies the first sensor and the second sensor as targets (step S1001). Here, the type of the sensor may be simply specified (for example, the first sensor is an RGB camera, and the second sensor is an IR camera), but specification information (manufacturer name, model, performance (resolution, frame rate), or the like) of each sensor may be specified in more detail.

Then, the model generation unit 403 requests the sensor information reading unit 404 to read a pair of the first sensor information and the second sensor information with respect to the combination of the first sensor and the second sensor specified in step S1001. In response to the read request, the sensor information reading unit 404 attempts to read the corresponding sensor information from the sensor information accumulation unit 402 (step S1002).

The combination of the first sensor information and the second sensor information to be paired is a combination of the first sensor information and the second sensor information sensed by the first sensor and the second sensor in the matching or approximate sensing environment. The sensing environment includes a place, date and time, weather, and the like when the sensor information is acquired. This is because, if a combination of the first sensor information and the second sensor information obtained by sensing the same object at the same place is used, the correlation between both pieces of sensor information is clear and it is easy to efficiently perform learning. If other pieces of sensing information such as date and time and weather (sunshine conditions) match or approximate, the learning can be more efficiently performed.

Here, the model generation unit 403 checks whether or not the sensor information reading unit 404 has been able to read a sufficient amount (for example, an amount sufficient for deep learning) of learning data from the sensor information accumulation unit 402 in step S1002 (step S1003).

In a case where a sufficient amount of learning data cannot be collected (No in step S1003), the model generation unit 403 gives up generation of the learned model at this timing, skips all subsequent processing steps, and ends the present processing. Note that the data collection unit 401 may request the first apparatus 201 for insufficient learning data.

Furthermore, in a case where a sufficient amount of learning data has been collected (Yes in step S1003), the model generation unit 403 performs learning of the neural network 501 using the pair of the first sensor information and the second sensor information collected as the learning data (step S1004).

Then, when the learning of the neural network 501 is completed, the model generation unit 403 accumulates the neural network 501 including the coupling weighting coefficient between the learned nodes (neurons) in the model accumulation unit 405 as the generated learned model in association with the specification information of the first sensor and the second sensor specified in step S1001 (step S1005), and this processing ends.

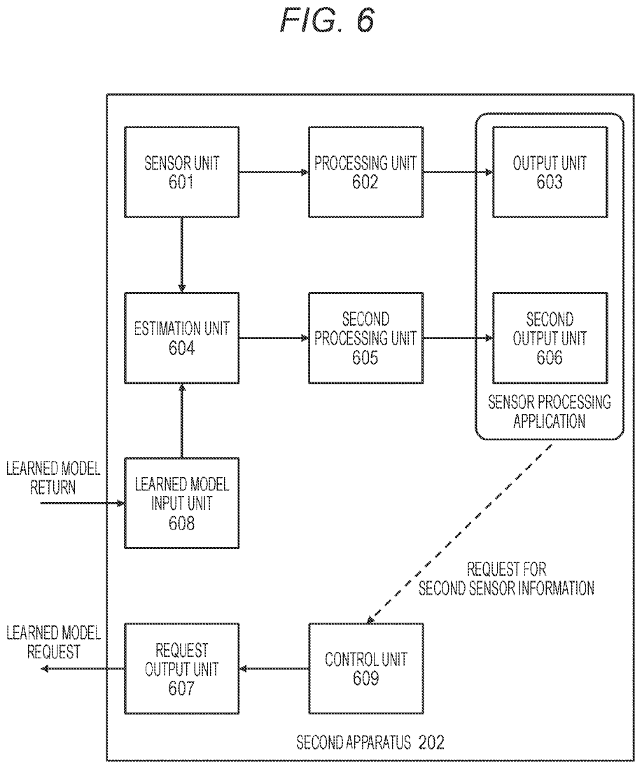

FIG. 6 schematically illustrates a functional configuration example of the second apparatus 202. The illustrated second apparatus 202 includes a sensor unit 601, a processing unit 602, an output unit 603, an estimation unit 604, a second processing unit 605, a second output unit 606, a request output unit 607, a learned model input unit 608, and a control unit 609. Note that each of the components 602 to 609 is implemented by executing a program on a processor such as a CPU, a GPU, or a GPGPU, or by a combination of the execution program and a hardware component in the second apparatus 202.

The sensor unit 601 includes one or more sensor elements including a first sensor. Here, for simplification of description, it is assumed that the sensor unit 601 includes only the first sensor. The processing unit 602 performs signal processing of first sensor information sensed by the first sensor of the sensor unit 601. For example, in a case where the first sensor is an RGB camera, the processing unit 602 performs development processing on an image signal output from the RGB camera.

The output unit 603 includes an application that processes the sensor information after the signal processing in the processing unit 602. For example, in a case where the first sensor as the sensor unit 601 includes an RGB camera, the output unit 603 includes a camera application that performs photographing. Furthermore, the output unit 603 may include a device such as a liquid crystal display that presents the sensor information to the user.

The estimation unit 604 performs processing of estimating second sensor information corresponding to first sensor information sensed by the first sensor as the sensor unit 601 using the learned model input to the learned model input unit 608 (described later). The second sensor information corresponding to first sensor information is second sensor information assumed to be sensed in a case where the second sensor is mounted in the second apparatus 202. The second processing unit 605 performs signal processing on the second sensor information output from the estimation unit 604.

Note that the sensor unit 601, the processing unit 602, the estimation unit 604, and the second processing unit 605 can also be configured as, for example, circuits of layers of a sensor element having a stacked structure.

The second output unit 606 includes an application that processes the second sensor information. In the apparatus configuration example illustrated in FIG. 6, the second output unit 606 performs output processing of the second sensor information estimated by the estimation unit 604. For example, in a case where the second sensor is an IR camera, the second output unit 606 performs processing of generating a visualized image indicating a color distribution corresponding to information of a heat distribution included in the IR image. Note that it is also assumed that the output unit 603 and the second output unit 606 are implemented by the operation of a single application (hereinafter, also referred to as “sensor processing application”) that processes the sensor information. Furthermore, the second output unit 606 may include a device such as a liquid crystal display that presents the estimated second sensor information to the user.

The request output unit 607 requests the learned model from the third apparatus 203. The learned model input unit 608 receives the learned model returned from the third apparatus 203 and sets the learned model in the estimation unit 604. The operation of setting the received learned model in the estimation unit 604 corresponds to, for example, processing in which the sensor processing application transfers the learned model to a layer corresponding to the estimation unit 604 in the sensor element of the stacked structure. The second apparatus 202 may acquire the latest learned model from the third apparatus 203 at any time according to a sequence of the learned model request and the learned model return with the third apparatus 203 (see FIG. 2).

The learned model input unit 608 receives the compressed bit stream of the learned model data transmitted from the third apparatus 203. Furthermore, when the size of the bit stream is large even after compression, the learned model data is divided into a plurality of pieces, and the compressed bit stream may be downloaded a plurality of times in some cases. The learned model input unit 608 receives the learned model data in units divided for each layer of the network or each region in the layer, for example. Then, the learned model input unit 608 sets the received learned model as a learned model to be used by the estimation unit 604. In a case where the learned model is represented by a neural network, the learned model input unit 608 receives the learned model including a set of nodes (neurons) and a set of coupling weighting coefficients between the nodes (neurons), and sets the coupling weighting coefficients to the neural network used by the estimation unit 604.

Note that when the request output unit 607 requests the learned model, the request output unit 607 may include meta-information designating the type and sensor specification information of the first sensor mounted on the sensor unit 601, and further specifying the type and specification information of the desired second sensor. In such a case, it is assumed that the learned model input unit 608 can receive the learned model suitable for the combination of the first sensor and the second sensor designated in the learned model request from the third apparatus 203.

The control unit 609 controls a request operation of the request output unit 607. For example, in response to generation of a request for presenting the second sensor information corresponding to first sensor information to the user from the sensor processing application (described above), the control unit 609 instructs the request output unit 607 to output the request for the learned model, and activates the operation of acquiring the learned model to be set in the estimation unit 606.

Alternatively, when receiving an instruction to download (new or update) the learned model from a user who operates the second apparatus 202 through a user interface (not illustrated) or the like, the control unit 609 instructs the request output unit 607 to request output of the learned model, and downloads the learned model used in the estimation unit 606. Furthermore, the control unit 608 instructs the request output unit 606 to output the request of the learned model at a predetermined cycle so that the learned model used by the estimation unit 606 always maintains the latest state. Furthermore, the control unit 609 may estimate the timing to download on the basis of the sensor information or the like acquired by the sensor unit 601, and instruct the request output unit 606 to output the request of the learned model. Artificial intelligence may be used for this estimation processing.

Furthermore, the control unit 609 may give an instruction on the request output of the learned model for pre-reading before the second sensor information is required in the second apparatus 202. In this case, a cache memory (not illustrated) for storing the pre-read learned model may be provided in the second apparatus 202. Furthermore, the learned model acquired in the past may be stored in the cache memory for reuse.

Furthermore, the control unit 609 may control the request output of the sensor type or the sensor specification of the second sensor on the basis of an instruction from the user or estimation processing. In this case, the request output unit 607 transmits the learned model request to the third apparatus 203 with the meta-information designating the sensor type and the sensor specification set by the control unit 609.

At the start of use of the second apparatus 202, for example, an initial value is set as a coupling weighting coefficient between nodes (neurons) in the neural network used by the estimation unit 606. Thereafter, each time the second apparatus 202 performs a sequence of a learned model request and a learned model return with the third apparatus 203 by using the request output unit 606 and the learned model input unit 607, the coupling weighting coefficient used in the estimation unit 606 can be updated.

### Second Embodiment

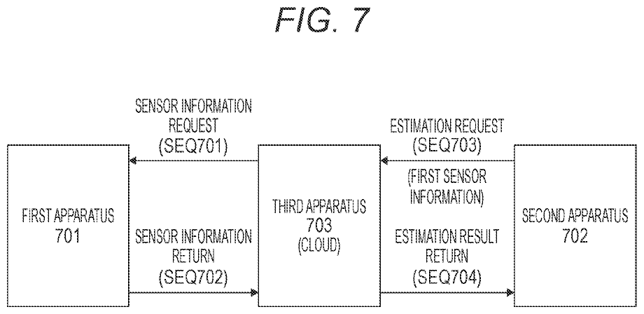

FIG. 7 schematically illustrates an operation sequence example of an artificial intelligence sensor system according to a second embodiment. In reality, the artificial intelligence sensor system has the configuration illustrated in FIG. 1, but in FIG. 7, for simplification, the artificial intelligence sensor system includes a first apparatus 701 that provides sensor information as learning data, a third apparatus 703 that learns a model on the basis of the sensor information provided from the first apparatus 701 and generates a learned model, and a second apparatus 702 to which a result of a service using the learned model is provided from the third apparatus 703. In the second embodiment, the result of the service is sensor information requested by the second apparatus 702. The third apparatus 703 estimates the sensor information requested by the second apparatus 702 from the sensor information transmitted from the second apparatus 702 using the learned model, and provides the estimation result as a service result.

The first apparatus 701 may be a terminal of a user such as a smartphone, a tablet, a PC, or a digital camera, a fixed point observation device such as an IoT device, a security camera, or a fixed point camera, a mobile device, an artificial satellite, or the like. Furthermore, the second apparatus 702 is assumed to be a terminal of the user such as a smartphone, a tablet, a PC, or a digital camera. Furthermore, the third apparatus 703 is configured by, for example, an artificial intelligence server (described above) installed on a cloud, on the assumption that deep learning is performed with a large number of pieces of learning data and a large number of nodes (neurons). It is assumed that the first apparatus 701 and the third apparatus 703 and the third apparatus 703 and the second apparatus 702 are interconnected via a network such as the Internet. However, the form of connection is not particularly limited.

The first apparatus 701 includes at least one of a first sensor or a second sensor, and provides sensor information as learning data to the third apparatus 703. Although only one first apparatus 201 is illustrated in FIG. 7 for simplification, it is assumed that an infinite number of first apparatuses each including a first sensor and providing first sensor information and an infinite number of first apparatuses each including a second sensor and providing second sensor information exist.

The third apparatus 703 generates a learned model for estimating sensor information. For convenience of description, it is assumed that the third apparatus 703 generates a learned model for processing of estimating second sensor information corresponding to first sensor information. Furthermore, the third apparatus 703 provides the second apparatus 702 with the second sensor information estimated using the learned model as a result of the service based on the learned model.

Then, the second apparatus 702 is equipped with the first sensor and not equipped with the second sensor, and can use the second sensor information corresponding to first sensor information sensed by the first sensor in response to the provision of the second sensor information estimated by the learned model as a result of the service based on the learned model generated by the third apparatus 703. Although only one second apparatus 702 is illustrated in FIG. 7 for simplification, there may be a plurality of second apparatuses to which the second sensor information estimated by the learned model is provided as a result of a service based on the learned model from the third apparatus 703.

Note that the relationship between the first sensor and the second sensor is basically in accordance with the above description, and a detailed description thereof will be omitted here.

Referring to FIG. 7, the third apparatus 703 requests sensor information from the first apparatus 701 (SEQ 701). On the other hand, the first apparatus 701 returns the first sensor information in a case of being equipped with the first sensor, and returns the second sensor information in a case of being equipped with the second sensor (SEQ 702).

The third apparatus 703 may perform the sensor information request in SEQ 701 in any format such as unicast communication or multicast communication addressed to a specific address or broadcast communication addressed to an unspecified address. Furthermore, the sensor information request may include meta-information designating desired sensor information, such as a type of sensor to be requested (whether the sensor is the first sensor or the second sensor), specification information of the sensor (manufacturer name, model, performance (resolution, frame rate), or the like), and a sensing environment (place, date, and time, weather, and the like where the sensor information is acquired).

Of course, in SEQ 701, the third apparatus 703 may transmit a request for the sensor information without particularly designating the sensor information, collect the sensor information from more first apparatuses 701, and then select or classify the sensor information collected in the third apparatus 703. The sensor information is preferably managed in the database so as to be searchable by the meta-information. The data stored in the database may be divided in units of blocks using a blockchain technology, and may be distributedly managed by adding hash data.

On the other hand, in a case where the sensor information request received in SEQ 701 is not addressed to the address of the first apparatus 701, the first apparatus 701 may discard this request and may not return the sensor information. Furthermore, in a case where the first apparatus 701 receives the sensor information request addressed to the first apparatus 701 or the sensor information request multicast or broadcast and the request includes meta-information designating the sensor information, the first apparatus 701 may return only the sensor information satisfying the condition designated by the meta-information in SEQ 702. Furthermore, in SEQ 702, the first apparatus 701 may return the sensor information by attaching, to the sensor information, meta-information indicating a type of sensor (whether the sensor is the first sensor or the second sensor), specification information of the sensor (manufacturer name, model, performance (resolution, frame rate), or the like), a sensing environment (place, date, and time, weather, and the like where the sensor information is acquired) or the like.

Note that, in the operation sequence example illustrated in FIG. 7, the first apparatus 701 returns the sensor information on the basis of the request from the third apparatus 703, but the sensor information may be autonomously transmitted to the third apparatus 703 regardless of the presence or absence of the request. For example, the first apparatus 701 may transmit the sensor information to the third apparatus 203 every predetermined period, or when the sensor information changes due to elapse of time, movement of an installation place of the apparatus, or the like.

The third apparatus 703 collects an enormous amount of pieces of first sensor information and second sensor information as learning data according to a sequence of sensor information requests (SEQ 701) and sensor information returns (SEQ 702) with an infinite number of first apparatuses 701. Then, the third apparatus 703 performs generation processing of a learned model for estimating second sensor information corresponding to first sensor information using the sensor information collected from the first apparatus 701 as learning data. In a case where the learned model is represented by a neural network, the third apparatus 703 accumulates the generated learned model.

The third apparatus 703 collects an enormous amount of learning data by continuously performing a sequence of a sensor information request (SEQ 701) and a sensor information return (SEQ 702), and appropriately performs relearning of a learned model to generate and hold a latest learned model.

The second apparatus 702 is equipped with a first sensor but not with a second sensor. Therefore, the second apparatus 702 transmits the first sensor information sensed by the first sensor to the third apparatus 703 and requests the second sensor information. On the other hand, the third apparatus 703 estimates the second sensor information corresponding to first sensor information received from the second apparatus 702 using the learned model and provides the second sensor information to the second apparatus 202. Accordingly, the second apparatus 702 may utilize the second sensor information without being equipped with the second sensor.

Referring again to FIG. 7, the second apparatus 702 transmits an estimation request to the third apparatus 703 with the first sensor information sensed by the first sensor in the second apparatus 702 attached to the estimation request (SEQ 703). On the other hand, the third apparatus 703 estimates the second sensor information corresponding to first sensor information received from the second apparatus 702 using the learned model and returns the second sensor information to the second apparatus 702 (SEQ 704). Accordingly, the second apparatus 702 can acquire, from the third apparatus 203, the second sensor information estimated by using the latest learned model at any time, by transmitting the first sensor information to the third apparatus 203.

When the second apparatus 702 transmits the first sensor information, the second apparatus 702 may include meta-information designating the type and sensor specification information of the first sensor mounted on the second apparatus 702, and further specifying the type and specification information of the desired second sensor. In such a case, it is sufficient that the third apparatus 703 returns the second sensor information estimated using the learned model suitable for the combination of the first sensor and the second sensor designated by the second apparatus 702 by the meta-information to the second apparatus 702.

Note that the second apparatus 702 transmits the first sensor information to the third apparatus 703 in response to generation of a request for use of the second sensor information corresponding to first sensor information from an application operating on the second apparatus 702 that handles the first sensor information, to request the second sensor information, for example. Alternatively, the second apparatus 702 may request the third apparatus 703 for the second sensor information in response to an instruction to convert the sensor information or the like from a user who operates the second apparatus 702 via a user interface or the like. Furthermore, the second apparatus 702 may convert the sensor information, infer the aspect to be presented to the user, and request the third apparatus 703 for the second sensor information according to the inference result. In this case, the second apparatus 702 may be equipped with artificial intelligence used to infer the necessity of the second sensor information.

In any case, the second sensor information that is assumed to be sensed in a case where the second sensor is mounted in the second apparatus 702 is provided to the second apparatus 702 from the third apparatus 703, and the second apparatus 702 can use the second sensor information.

The first apparatus 701 in the second embodiment may basically have a configuration similar to that of the first apparatus 201 in the first embodiment (for details, refer to FIG. 3 and the description described above related to FIG. 3). Accordingly, the description of the functional configuration of the first apparatus 701 is omitted here.

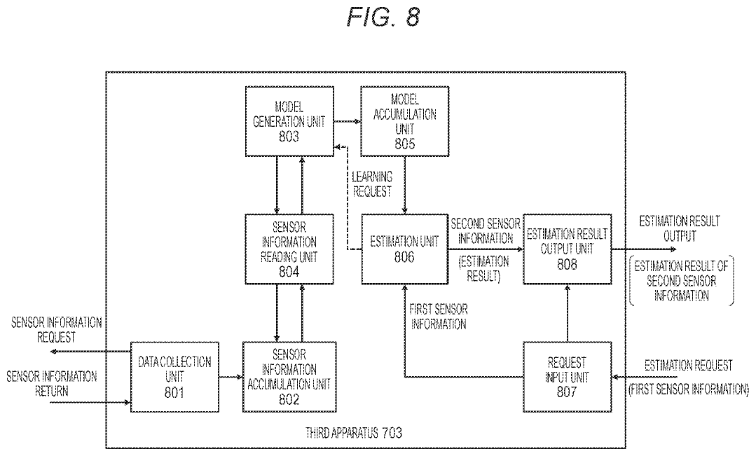

FIG. 8 schematically illustrates a functional configuration example of the third apparatus 703. The illustrated third apparatus 703 includes a data collection unit 801, a sensor information accumulation unit 802, a model generation unit 803, a sensor information reading unit 804, a model accumulation unit 805, an estimation unit 806, a request input unit 807, and an estimation result output unit 808. Note that each of the components 801 to 808 is implemented by executing a program on a processor such as a CPU, a GPU, or a GPGPU, or by a combination of the execution program and a hardware component in the third apparatus 703.

The data collection unit 801 performs processing of generating a learned model and collecting learning data to be used for relearning. Specifically, the data collection unit 801 transmits a sensor information request to an infinite number of first apparatuses 701, receives the first sensor information or the second sensor information returned from each of the first apparatuses 701, and stores the first sensor information or the second sensor information in the sensor information accumulation unit 802 as learning data. The sensor information request to be transmitted to first apparatus 701 may be attached with meta-information designating a sensor type or a sensor specification.

However, it is also assumed that the sensor information is regularly or irregularly pushed from the first apparatus 701 without the sensor information request transmitted, but in this case as well, the data collection unit 801 performs reception processing and stores the sensor information in the sensor information accumulation unit 802.

Furthermore, the sensor information transmitted from the first apparatus 701 may be attached with meta-information indicating the type of sensor, the specification information of the sensor, and the sensing environment. The data collection unit 801 stores the sensor information collected from the first apparatus 701 in the sensor information accumulation unit 802 in association with the type of the sensor, the specification information of the sensor, and the sensing environment.

The sensor information reading unit 804 reads the first sensor information and the second sensor information to be the learning data from the sensor information accumulation unit 802, and supplies the first sensor information and the second sensor information to the model generation unit 803. However, when reading the sensor information, the sensor information reading unit 804 pairs a combination of the first sensor information and the second sensor information in which the sensing environments match or approximate to each other, reads the combination from the sensor information accumulation unit 802, and supplies the combination to the model generation unit 803.

The model generation unit 803 performs generation of a learned model for performing processing of estimating second sensor information corresponding to first sensor information by using as learning data the sensor information received from the sensor information reading unit 804. Then, the model generation unit 803 generates a learned model that enables estimation of the second sensor information corresponding to first sensor information, and then stores the learned model in the model accumulation unit 805. In a case where the learned model is represented by a neural network, a neural network having a set of coupling weighting coefficient between learned nodes (neurons) is stored in the model accumulation unit 805 as a learned model.

Note that the first sensor and the second sensor may be further finely classified for each specification or performance. Therefore, the model generation unit 803 may generate a learned model for each combination of specifications and performance. In this case, the sensor information reading unit 804 reads the first sensor information and the second sensor information corresponding to the specification and performance to be subjected to model generation, and the model generation unit 803 generates the learned model for each combination of the specification and the performance. Then, the model accumulation unit 805 accumulates a learned model for each combination of specifications and performance. Since the mechanism by which the model generation unit 803 generates the learned model is similar to that in FIG. 5, detailed description thereof will be omitted here.

When the estimation request with the first sensor information is input from the second apparatus 702, the request input unit 807 passes the received first sensor information to the estimation unit 806. The estimation request may include meta-information related to the sensor type and the sensor specification of the first sensor and the sensor type and the sensor specification of the second sensor to be estimated. The estimation unit 806 selectively reads the learned model corresponding to the combination of the first sensor and the second sensor designated by the meta-information from the model accumulation unit 805. Then, the estimation unit 806 estimates the second sensor information corresponding to first sensor information received from the second apparatus 702 using the read learned model. In a case where the learned model is represented by a neural network, the estimation unit 806 selectively reads the learned model including a set of coupling weighting coefficients between nodes (neurons) from the model accumulation unit 804, and performs estimation processing using the neural network in which the coupling weighting coefficients are set. The estimation result output unit 808 returns the second sensor information estimated by the estimation unit 807 to the second apparatus 202.

The request for the learned model from the second apparatus 702 may include the meta-information designating the type and sensor specification information of the first sensor mounted on the second apparatus 702, and the type and specification information of the desired second sensor. In such a case, it is sufficient that the estimation unit 806 selectively reads the learned model suitable for the combination of the first sensor and the second sensor designated by the second apparatus 202 from the model accumulation unit 805 and estimates the second sensor information corresponding to first sensor information received from the second apparatus 702.

Note that, in a case where it is assumed that the third apparatus 703 is installed as a server on a cloud, all the functional components 801 to 808 illustrated in FIG. 4 are not necessarily implemented in a single server apparatus. For example, it is also assumed that a function of collecting and accumulating learning data and a function of generating a learned model using the accumulated learning data are arranged on different server apparatuses.

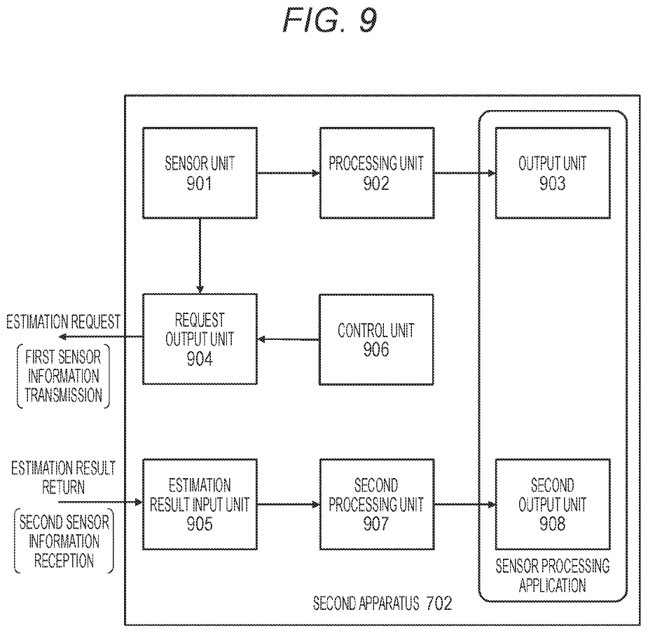

FIG. 9 schematically illustrates a functional configuration example of the second apparatus 702. The illustrated second apparatus 702 includes a sensor unit 901, a processing unit 902, an output unit 903, a request output unit 904, an estimation unit 604, an estimation result input unit 905, a control unit 906, a second processing unit 907, and a second output unit 908. Note that each of the components 902 to 908 is implemented by executing a program on a processor such as a CPU, a GPU, or a GPGPU, or by a combination of the execution program and a hardware component in the second apparatus 202.

The sensor unit 901 includes one or more sensor elements including a first sensor. Here, for simplification of description, it is assumed that the sensor unit 901 includes only the first sensor. The processing unit 902 performs signal processing of first sensor information sensed by the first sensor of the sensor unit 901. For example, in a case where the first sensor is an RGB camera, the processing unit 902 performs development processing on an image signal output from the RGB camera.

The output unit 903 includes an application that processes the sensor information after the signal processing in the processing unit 902. For example, in a case where the first sensor as the sensor unit 901 includes an RGB camera, the output unit 903 includes a camera application that performs photographing. Furthermore, the output unit 903 may include a device such as a liquid crystal display that presents the sensor information to the user.

The request output unit 904 transmits the estimation request to the third apparatus 703 with the first sensor information sensed by the first sensor mounted on the sensor unit 901 attached to the estimation request. The third apparatus 703 returns the second sensor information estimated on the basis of the first sensor information. The second sensor information returned from the third apparatus 703 is second sensor information assumed in a case where the second sensor is mounted in the second apparatus 202.

Note that when the request output unit 904 transmits the estimation request, the request output unit 904 may include meta-information designating the type and sensor specification information of the first sensor mounted on the sensor unit 901, and further designating the type and specification information of the desired second sensor. In such a case, it is assumed that the third apparatus 703 returns the second sensor information estimated using the learned model suitable for the combination of the first sensor and the second sensor designated in the learned model request.

Upon receiving the second sensor information from the third apparatus 703, the estimation result input unit 905 passes the second sensor information to the second processing unit 907. The second sensor information received from the third apparatus 703 is second sensor information assumed to be sensed in a case where the second sensor is mounted in the second apparatus 702. The second processing unit 907 performs signal processing of the second sensor information.

Note that the sensor unit 901, the processing unit 902, and the second processing unit 907 can also be configured as, for example, circuits of layers of a sensor element having a stacked structure.

The second output unit 907 includes an application that processes the second sensor information. In the apparatus configuration example illustrated in FIG. 9, the second output unit 907 processes the second sensor information returned from the third apparatus 703. For example, in a case where the second sensor is an IR camera, the second output unit 907 performs processing of generating a visualized image indicating a color distribution corresponding to information of a heat distribution included in the IR image. Note that it is also assumed that the output unit 903 and the second output unit 907 are implemented by the operation of a single application (hereinafter, also referred to as “sensor processing application”) that processes the sensor information.

The control unit 906 controls a request operation of the request output unit 904. For example, in response to generation of a request for presenting the second sensor information corresponding to first sensor information to the user from the sensor processing application (described above), the control unit 906 instructs the request output unit 904 to output the request for the learned model, and activates the operation of acquiring the second sensor information corresponding to first sensor information.

Furthermore, the control unit 906 may control the request output of the sensor type or the sensor specification of the second sensor on the basis of an instruction from the user or estimation processing. In this case, the request output unit 904 transmits the estimation request to the third apparatus 703 with the meta-information designating the sensor type and the sensor specification set by the control unit 906.

As described above, the second apparatus 702 transmits the first sensor information sensed by the first sensor of the second apparatus 702 to the third apparatus 703, so that the second sensor information corresponding to first sensor information is also available.

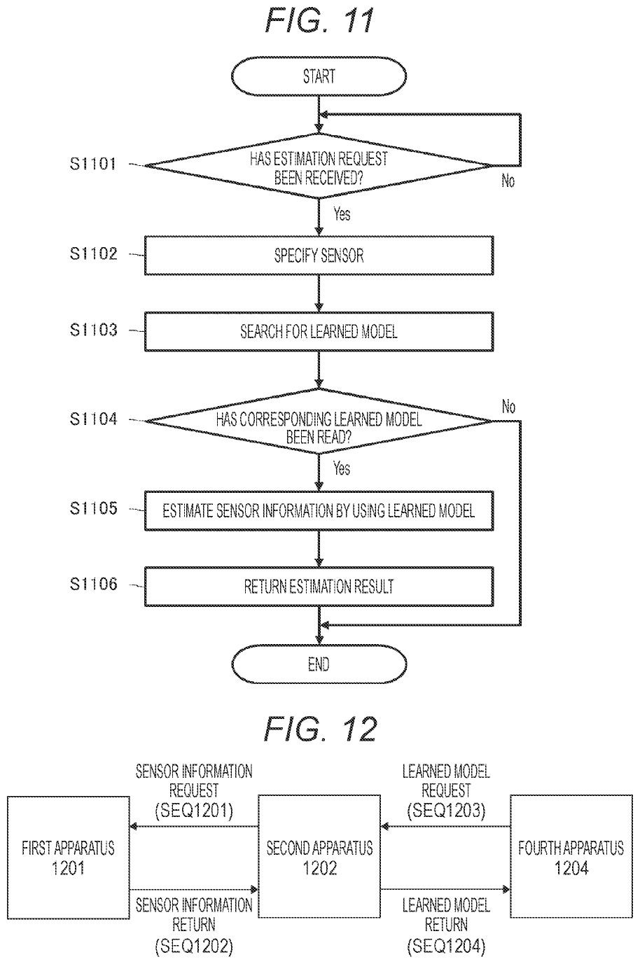

FIG. 11 illustrates a processing procedure for returning the second sensor information estimated from the first sensor information in response to the estimation request from the second apparatus 702 in the third apparatus 703 in the form of a flowchart. It is assumed that the third apparatus 703 accumulates one or more learned models generated on the basis of the enormous learning data collected from the large number of first apparatuses 701 in the model accumulation unit 805 before starting this processing procedure. Furthermore, it is assumed that the learned model is generated in the third apparatus 703 according to the processing procedure similarly to FIG. 10.

When the request input unit 807 receives the estimation request from the second apparatus 702 (Yes in step S1001), the estimation unit 806 specifies the target first sensor and second sensor on the basis of the meta-information attached to the estimation request (step S1102). Here, the type of the sensor may be simply specified (for example, the first sensor is an RGB camera, and the second sensor is an IR camera), but specification information (manufacturer name, model, performance (resolution, frame rate), or the like) of each sensor may be specified in more detail.

Then, the estimation unit 806 requests the model accumulation unit 805 to read the learned model corresponding to the combination of the first sensor and the second sensor specified in step S1102 (step S1103). In response to the read request, the model accumulation unit 805 searches for the corresponding learned model.

Here, in a case where the corresponding learned model cannot be read from the model accumulation unit 805 (or in a case where learning has not been completed yet) (No in step S1104), the second sensor information cannot be estimated from the first sensor information requested to be estimated by the second apparatus 702, and thus, all subsequent processing steps are skipped, and this processing ends. Note that, in this case, the estimation result output unit 808 may return information indicating that the second sensor information estimation processing cannot be performed to the second apparatus 702 that is the request source. Furthermore, the estimation unit 806 may request the model generation unit 803 to generate a learned model regarding the combination of the first sensor and the second sensor requested for estimation from the second apparatus 702.

On the other hand, in a case where the learned model corresponding to the estimation request from the second apparatus 702 can be read from the model accumulation unit 805 (Yes in step S1104), the estimation unit 806 estimates the second sensor information corresponding to first sensor information transmitted from the second apparatus 702 in a state of being attached to the estimation request, by using the learned model (step S1105). Then, the estimation result output unit 808 returns the second sensor information of the estimation result to the second apparatus 702 that is the request source (step S1106), and this processing ends.

### Third Embodiment

Each of the artificial intelligence sensor systems according to the first embodiment and the second embodiment has a configuration in which the third apparatus that provides the learned model for estimating second sensor information corresponding to first sensor information is interposed, and a result of a service using the learned model is provided from the third apparatus to the second apparatus. On the other hand, in the third embodiment, the third apparatus is not interposed, and the second sensor information is estimated using a learned model learned by the second apparatus.

FIG. 12 schematically illustrates an operation sequence example of an artificial intelligence sensor system according to the third embodiment. In reality, the artificial intelligence sensor system has the configuration illustrated in FIG. 1, but in FIG. 12, for simplification, the artificial intelligence sensor system includes a first apparatus 1201 that provides sensor information as learning data, and a second apparatus 1202 that generates the learned model on the basis of the provided sensor information and uses the learned model.

The first apparatus 1201 includes at least a second sensor, and provides second sensor information as learning data to the second apparatus 1202. On the other hand, the second apparatus 1202 is equipped with a first sensor. The second apparatus 1202 generates a learned model for estimating second sensor information corresponding to first sensor information by using the first sensor information sensed in the second apparatus 1202 and the second sensor information provided from the first apparatus 1201 as learning data. Furthermore, the second apparatus 1202 estimates the second sensor information corresponding to first sensor information obtained from the first sensor by using the learned model generated in the second apparatus 1202. Moreover, the second apparatus 1202 may provide the learned model generated in the second apparatus 1202 to another apparatus (in FIG. 12, a fourth apparatus 1204). The fourth apparatus 1204 may be an apparatus corresponding to the second apparatus to which the result of the service is provided from the outside in the first embodiment and the second embodiment. Alternatively, the fourth apparatus 1204 may be a learned model providing server that collects learned models from the second apparatus 1202, creates a database, and manages the learned models. It is assumed that the first apparatus 1201 and the second apparatus 1202 and the second apparatus 1202 and the fourth apparatus 1204 are interconnected via a network such as the Internet. However, the form of connection is not particularly limited.

Note that the relationship between the first sensor and the second sensor is basically in accordance with the above description, and a detailed description thereof will be omitted here.

Referring to FIG. 12, the second apparatus 1202 requests second sensor information from the first apparatus 1201 (SEQ 1201). In response to this, the first apparatus 1201 returns the second sensor information sensed by the second sensor mounted on the first apparatus 1201 (SEQ 1202).

Furthermore, the second apparatus 1202 acquires the first sensor information from the first sensor mounted on the second apparatus 1202. Accordingly, the second apparatus 1202 can collect the first sensor information and the second sensor information as the learning data by an amount corresponding to the number of repetitions by repeatedly performing the sequence of the sensor information request (SEQ 1201) and the sensor information return (SEQ 1202) with the first apparatus 1201.

The second apparatus 1202 performs generation of a learned model for estimating second sensor information corresponding to first sensor information using the sensor information as learning data. Here, the learned model is represented by a neural network formed by coupling between nodes (neurons), and the learned model can be generated by changing a coupling weighting coefficient between nodes (neurons) in the neural network by learning (training). The second apparatus 1202 accumulates a learned model having a set of coupling weighting coefficients obtained by learning.

Then, the second apparatus 1202 can estimate the second sensor information corresponding to first sensor information from the first sensor mounted on the second apparatus 1202 by using the learned model. Furthermore, upon receiving the learned model request from the fourth apparatus 1204 (SEQ 1203), the second apparatus 1202 returns the learned model to the fourth apparatus 1204 (SEQ 1204).

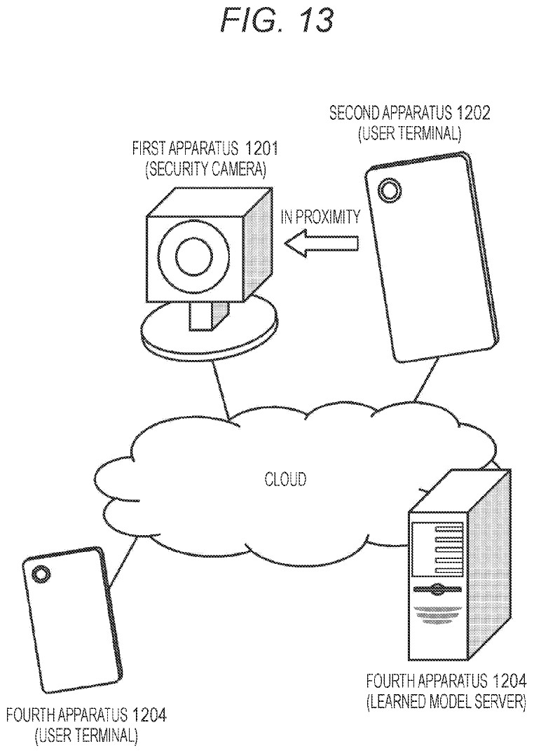

FIG. 13 illustrates a specific example of the artificial intelligence sensor system according to the third embodiment. The first apparatus 1201 is, for example, a security camera including an IR camera, and is used by being fixed to a building or the like. Furthermore, the second apparatus 1202 is a terminal of a user such as a smartphone, a tablet, or a digital camera equipped with an RGB camera, and can be moved to any place. Furthermore, the fourth apparatus 1204 may be an information terminal such as a smartphone, a tablet, a PC, or a digital camera, and performs estimation processing of the second sensor information by using a learned model acquired from second apparatus 1202. Alternatively, the fourth apparatus 1204 may be a learned model providing server that collects learned models from the second apparatus 1202, creates a database, and manages the learned models. The learned model providing server performs an operation of returning the learned model to the learned model request from the outside.

In order for the second apparatus 1202 to efficiently generate a learned model for estimating second sensor information corresponding to first sensor information, the second sensor information sensed under a sensing environment that matches or approximates that of the first sensor in the second apparatus 1202 is necessary. Therefore, in the example illustrated in FIG. 13, a user of a smartphone as the second apparatus 1202 can easily acquire the first sensor information and the second sensor information sensed in the matching or approximate sensing environment by manual work of bringing the smartphone close to a security camera as the first apparatus 1201.

The first apparatus 1201 in the third embodiment may basically have a configuration similar to that of the first apparatus 201 in the first embodiment (for details, refer to FIG. 3 and the description described above related to FIG. 3). Accordingly, the description of the functional configuration of the first apparatus 1201 is omitted here.

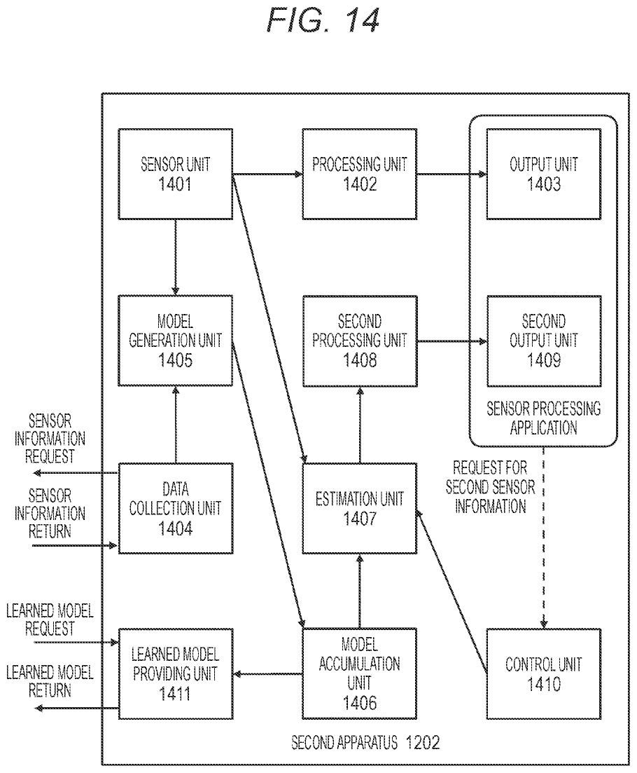

FIG. 14 schematically illustrates a functional configuration example of the second apparatus 1202. The illustrated second apparatus 1202 includes a sensor unit 1401, a processing unit 1402, an output unit 1403, a data collection unit 1404, a model generation unit 1405, a model accumulation unit 1406, an estimation unit 1407, a second processing unit 1408, a second output unit 1409, a control unit 1410, and a learned model providing unit 1411. Note that each of the components 1402 to 1411 is implemented by executing a program on a processor such as a CPU, a GPU, or a GPGPU, or by a combination of the execution program and a hardware component in the second apparatus 1202.

The sensor unit 1401 includes one or more sensor elements including a first sensor. Here, for simplification of description, it is assumed that the sensor unit 1401 includes only the first sensor. The processing unit 1402 performs signal processing of first sensor information sensed by the first sensor of the sensor unit 1401. For example, in a case where the first sensor is an RGB camera, the processing unit 1402 performs development processing on an image signal output from the RGB camera.

The output unit 1403 includes an application that processes the sensor information after the signal processing in the processing unit 1402. For example, in a case where the first sensor as the sensor unit 1401 is an RGB camera, the output unit 1403 includes a camera application that performs photographing. Furthermore, the output unit 1403 may include a device such as a liquid crystal display that presents the sensor information to the user.

The data collection unit 1404 performs processing of generating a learned model and collecting learning data to be used for relearning. Specifically, the data collection unit 1404 transmits a sensor information request to the first apparatus 1201 in proximity by manual work of the user or the like, and receives the second sensor information returned from the first apparatus 1201 and passes the second sensor information to the model generation unit 1405. In a case where it is desired to collect a plurality of pieces of learning data from the same first apparatus 1201, the data collection unit 1404 repeats a sequence of a sensor information request and a data information return with the first apparatus 1201 a plurality of times. The sensor information request to be transmitted to first apparatus 1201 may be attached with meta information specifying a sensor type or a sensor specification.

The model generation unit 1405 generates a learned model that performs processing of estimating second sensor information corresponding to first sensor information by using, as learning data, a pair of the second sensor information collected by the data collection unit 1404 from the first apparatus 1201 and the first sensor information sensed by the sensor unit 1401 at the same time. The model generation unit 1405 may include a memory (not illustrated) for accumulating a plurality of pieces of learning data, and generate the learned model on the basis of the learning data read from the memory. In a case where the artificial intelligence model to be learned is represented by a neural network, the model generation unit 1405 generates a learned model having a set of coupling weighting coefficients between nodes (neurons) obtained by learning.

The model generation unit 1405 stores the learned model in the model accumulation unit 1406. The model accumulation unit 1406 may accumulate the learned model in association with the sensor types and sensor specifications of the first sensor and the second sensor to be learned.

The estimation unit 1407 estimates the second sensor information corresponding to first sensor information sensed by the first sensor of the sensor unit 1401 using the learned model selectively read from the model accumulation unit 1406. As described above, the learned model read from the model accumulation unit 1406 is a learned model learned by the model generation unit 1405. Furthermore, the second sensor information corresponding to first sensor information is second sensor information assumed to be sensed in a case where the second sensor is mounted in the second apparatus 1202. The second processing unit 1408 performs signal processing on the second sensor information output from the estimation unit 1407.

Note that the sensor unit 1401, the processing unit 1402, the estimation unit 1407, and the second processing unit 1408 can also be configured as, for example, circuits of layers of a sensor element having a stacked structure.

The second output unit 1409 includes an application that processes the second sensor information. In the apparatus configuration example illustrated in FIG. 14, the second output unit 1409 performs output processing of the second sensor information estimated by the estimation unit 1407. For example, in a case where the second sensor is an IR camera, the second output unit 1409 performs processing of generating a visualized image indicating a color distribution corresponding to information of a heat distribution included in the IR image. Note that it is also assumed that the output unit 1403 and the second output unit 1409 are implemented by the operation of a single application (hereinafter, also referred to as “sensor processing application”) that processes the sensor information.

The control unit 1410 controls the operation of estimating the second sensor information by the estimation unit 1407. For example, in response to generation of a request for presenting the second sensor information corresponding to first sensor information to the user from the sensor processing application (described above), the control unit 1410 instructs the estimation unit 1407 to perform estimation processing of the second sensor information.

The learned model providing unit 1411 provides a learned model to the fourth apparatus 1204. That is, upon receiving the learned model request from the fourth apparatus 1204, the learned model providing unit 1411 selectively reads the learned model from the model accumulation unit 1406 and returns the learned model to the fourth apparatus 1204.

The request for the learned model from the fourth apparatus 1204 may include meta-information designating the type and specification information of the desired first sensor and second sensor. In such a case, it is sufficient that the learned model providing unit 1411 selectively reads the learned model suitable for the combination of the first sensor and the second sensor designated by the meta-information by the fourth apparatus 1204 from the model accumulation unit 1406 and returns the learned model to the fourth apparatus 1204 as the request source.

Furthermore, the learned model providing unit 1411 may compress the bit stream of the learned model data and transmit the compressed bit stream to the fourth apparatus 1204. Furthermore, when the size of the bit stream is large even after compression, the learned model data may be divided into a plurality of pieces, and the compressed bit stream may be transmitted a plurality of times. When the learned model data is divided, the learned model data may be divided for each layer of the network or for each region in the layer.

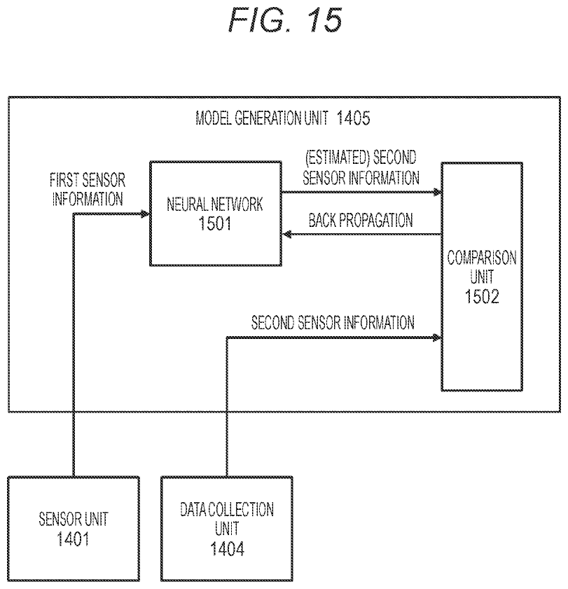

FIG. 15 illustrates a mechanism in which the model generation unit 1405 performs generation of a learned model.

The model generation unit 1405 includes a neural network 1501 as artificial intelligence that performs processing of estimating second sensor information corresponding to first sensor information. Furthermore, the model generation unit 1405 further includes a comparison unit 1502 that compares the output of the neural network 1501 with the training data.

The data collection unit 1404 supplies the second sensor information acquired from the first apparatus 1201 to the model generation unit 1405. Furthermore, in synchronization with the timing of acquiring the second sensor information from the first apparatus 1201, the first sensor information sensed by the first sensor of the sensor unit 1401 is input to the model generation unit 1405.

As described with reference to FIG. 13, learning or acquisition of learning data is performed in a state where the second apparatus 1202 is brought close to the first apparatus 1201. Accordingly, the first sensor information and the second sensor information input to the model generation unit 1405 from the data collection unit 1404 and the sensor unit 1401, respectively, can be treated as paired learning data with matching or approximating sensing environments (place, date and time, weather, and the like when the sensor information is acquired).

The neural network 1501 estimates the second sensor information from the first sensor information supplied from the sensor unit 1401. Then, the comparison unit 1502 compares the second sensor information estimated by the neural network 1501 with the second sensor information collected by the sensor information collection unit 1404 from the first apparatus 1201. That is, the second sensor information paired with the first sensor information is used as training data, and a loss function based on a difference between the training data and the second sensor information estimated by the neural network 1501 is defined. Then, the learning of the neural network 1501 is performed by back propagation so as to minimize the loss function. A learned model having a set of coupling weighting coefficients between nodes (neurons) in the neural network 1501 when the loss function is minimized is stored in the model accumulation unit 1406 (not illustrated in FIG. 15).

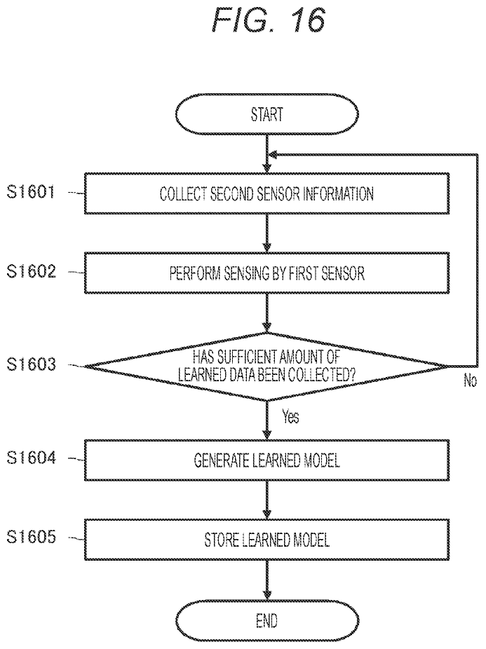

FIG. 16 illustrates a processing procedure for generating the learned model in the second apparatus 1202 in the form of flowchart.

First, a sensor information request is transmitted to the first apparatus 1201 in proximity by manual work of the user or the like, and the data collection unit 1401 collects the second sensor information returned from the first apparatus 1201 (step S1601).

Furthermore, at the same time when the second sensor information is acquired from the first apparatus 1201 in step S1601, the first sensor information sensed by the first sensor of the sensor unit 1401 is acquired (step S1602).

The first sensor information and the second sensor information acquired in steps 51601 and 51602 can be treated as paired learning data with matching or approximating sensing environments (place, date and time, weather, and the like when the sensor information is acquired). The model generation unit 1405 stores the paired learning data in an internal memory or the like.

Until a sufficient amount of learning data is collected (No in step S1603), the process returns to step S1601 and the collection of learning data is repeated. In step S1601, the data collection unit 1401 may request the first apparatus 1201 for insufficient learning data.

Then, in a case where a sufficient amount of learning data has been collected (Yes in step S1603), the model generation unit 1405 performs learning of the neural network 1501 using the pair of the first sensor information and the second sensor information collected as the learning data (step S1604).

Then, when the learning of the neural network 1501 is completed, the model generation unit 1405 accumulates the learned model including the coupling weighting coefficient between the nodes (neurons) in the model accumulation unit 1406 in association with the specification information of the first sensor and the second sensor (step S1605), and this processing ends.

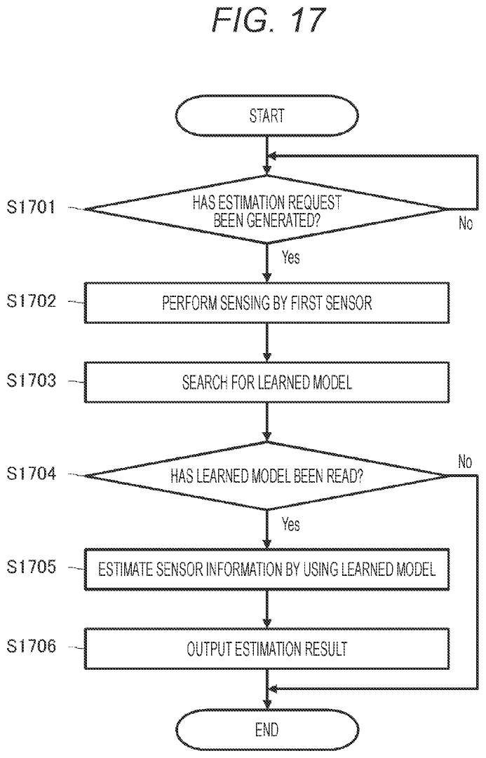

FIG. 17 illustrates a processing procedure for estimating the second sensor information in response to an estimation request from a sensor processing application or the like in the second apparatus 1202 in the form of a flowchart. It is assumed that the second apparatus 1202 accumulates a learned model learned on the basis of a pair of the first sensor information sensed by the first sensor of the sensor unit 1401 and the second sensor information collected from the first apparatus 1201 in the model accumulation unit 1406 before starting this processing procedure.

For example, in response to generation of a request for presenting the second sensor information corresponding to first sensor information to the user from the sensor processing application (described above) (Yes in step S1701), the control unit 1410 instructs the estimation unit 1407 to perform estimation processing of the second sensor information.

The estimation unit 1407 acquires first sensor information sensed by the first sensor of the sensor unit 1401 (step S1702). Furthermore, the estimation unit 1407 attempts to selectively read the learned model used for estimation of the second sensor information from the model accumulation unit 1406 (step S1703).

Here, in a case where the corresponding learned model cannot be read from the model accumulation unit 1406 (or in a case where learning has not been completed yet) (No in step S1704), the second sensor information corresponding to first sensor information cannot be estimated, and thus, all subsequent processing steps are skipped, and this processing ends. Note that, in this case, information indicating that the second sensor information estimation processing cannot be performed may be presented to the user through the second output unit 1409 or the like.

On the other hand, in a case where the corresponding learned model can be read from the model accumulation unit 1406 (Yes in step S1704), the estimation unit 1407 estimates the second sensor information corresponding to first sensor information sensed by the first sensor of the sensor unit 1401, by using the learned model (step S1705). Then, after the second processing unit 1408 processes the estimation result, the second output unit 808 outputs the estimation result (step S1706), and this processing ends.

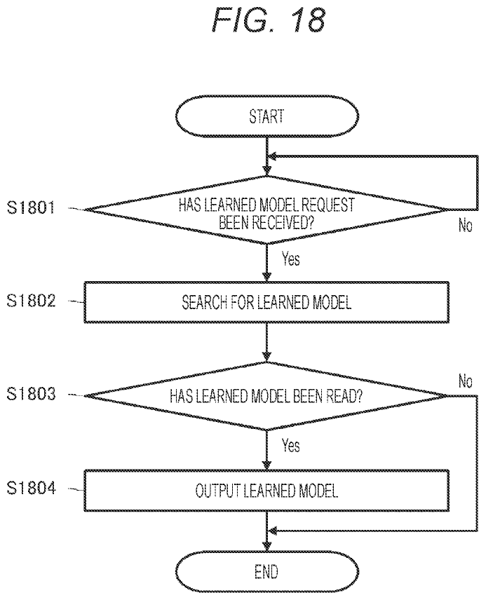

FIG. 18 illustrates a processing procedure for the second apparatus 1202 to provide the learned model to an external device in the form of a flowchart. The external device mentioned here corresponds to the fourth apparatus 1204 in FIG. 12. The external device may be an artificial intelligence server disposed on a cloud.

Upon receiving the learned model request from the fourth apparatus 1204 (Yes in step S1801), the learned model providing unit 1411 attempts to selectively read a learned model that matches the request from the model accumulation unit 1406 (step S1802).

Here, in a case where the corresponding learned model cannot be read from the model accumulation unit 1406 (or in a case where learning has not been completed yet) (No in step S1803), the learned model providing unit 1411 skips all subsequent processing steps, and this processing ends. Note that, in this case, the learned model providing unit 1411 may notify the fourth apparatus 1204 that is the request source that the learned model cannot be provided.

On the other hand, in a case where the corresponding learned model can be read from the model accumulation unit 1406 (Yes in step S1803), the learned model providing unit 1411 returns the learned model to the fourth apparatus 1204 that is the request source, and this processing ends.

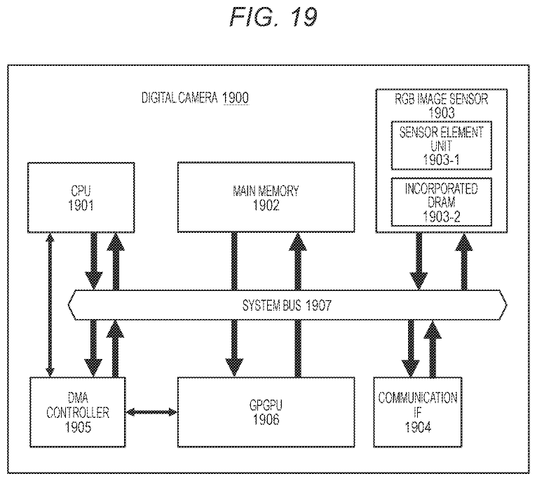

FIG. 19 illustrates an internal configuration example of a digital camera 1900 as a specific example of the second apparatus 1202. The illustrated digital camera 1900 includes a CPU 1901, a main memory 1902, an RGB image sensor 1903, a communication interface (IF) 1904, a direct memory access (DMA) controller 1905, and a GPGPU (or a neural network accelerator) 1906, and each unit is interconnected with each component via a system bus 1907. Note that the digital camera 1900 may include other components, but illustration thereof is omitted in FIG. 19 for simplification of the drawing. Furthermore, the neural network accelerator may be implemented as one processor mounted inside the CPU 1901 or the GPGPU 1906.

The CPU 1901 can directly access the main memory 1902. Furthermore, the main memory 1902 can be configured as a virtual storage or a share degree memory together with an extension memory or an external storage device (not illustrated). In this case, the CPU 1901 and the GPGPU 1906 can access other than the main memory via the DMA controller 1905. Furthermore, the external device connected via the communication interface 1904 can access the main memory 1902 by making a DMA request to the DMA controller 1905.

The RGB image sensor 1903 corresponds to a first sensor (or a general-purpose sensor). The RGB image sensor 1903 includes a sensor element unit 1903-1 and an incorporated dynamic random access memory (DRAM) 1903-2. The sensor element unit 1903-1 includes a sensor element such as a charge coupled device (CCD) or a CMOS, and a signal processing circuit that processes a sensor signal. Furthermore, the sensor element unit 1903-1 can perform signal processing of estimating sensor information (second sensor information) sensed by another sensor (second sensor) from original sensor information (first sensor information) obtained from the sensor element unit 1903-1 on the basis of a learned model (that is, the learned artificial intelligence model) set in the incorporated DRAM 1903-2.

The GPGPU 1906 is a processing unit that can be used for general purposes, but here, it is assumed that a part of an artificial intelligence model generation program (software) is operated by the CPU 1901 and a part specialized for processing of a neural network is operated by the GPGPU 1906, thereby being used for generation processing of a learned model. The learned model here refers to a learned model that estimates other sensor information corresponding to sensor information (first sensor information) sensed by the RGB image sensor 1903. Furthermore, the other sensor information is specifically second sensor information sensed by the IR sensor as the second sensor.

The communication interface 1904 is a functional module that interconnects with a network via a wired or wireless medium. Here, the communication interface 1904 is used to acquire training data used for generation of a learned model in the GPGPU 1906 via a network. Furthermore, the training data is second sensor information sensed by the IR sensor as the second sensor. The communication interface 1904 is used, for example, when the learned model is transmitted to the artificial intelligence server according to a request of the artificial intelligence server or by a push method.

In the GPGPU 1906, a pair of the second sensor information acquired via the communication interface 1904 and the first sensor information sensed by the RGB image sensor 1903 as the first sensor at the same time is used as learning data, and generation processing of a learned model for performing processing of estimating second sensor information corresponding to first sensor information is performed. In a case where the artificial intelligence model to be learned is represented by a neural network, the GPGPU 1906 obtains a set of coupling weighting coefficients between learned nodes (neurons) as a result of generating a learned model on the basis of the artificial intelligence model. Then, the GPGPU 1906 stores the generated learned model in the main memory 1902 through the intervention of the DMA controller 1905. Note that, since the mechanism for generating the learned model has already been described with reference to FIG. 15, detailed description thereof will be omitted here.

The CPU 1901 requests the RGB image sensor 1903 to estimate IR image information as second sensor information corresponding to the RGB captured image as first sensor information. When this estimation request is generated, the learned model stored in the main memory 1902 is transferred to the RGB image sensor 1903 and written in the incorporated DRAM 1903-2 by the intervention of the DMA controller 1904. In this case, the sensor element unit 1903-1 performs signal processing of estimating sensor information (second sensor information) sensed by another sensor (second sensor) from original sensor information (first sensor information) obtained from the sensor element unit 1903-1 on the basis of a learned model set in the incorporated DRAM 1903-2.

Furthermore, in a case where the communication interface 1904 receives the learned model request from the fourth apparatus 1204, the learned model stored in the main memory 1902 is transferred to the communication interface 1904 through the intervention of the DMA controller 1905, and in the communication interface 1904, return processing of the learned model to the fourth apparatus 1204 of the request source is performed.

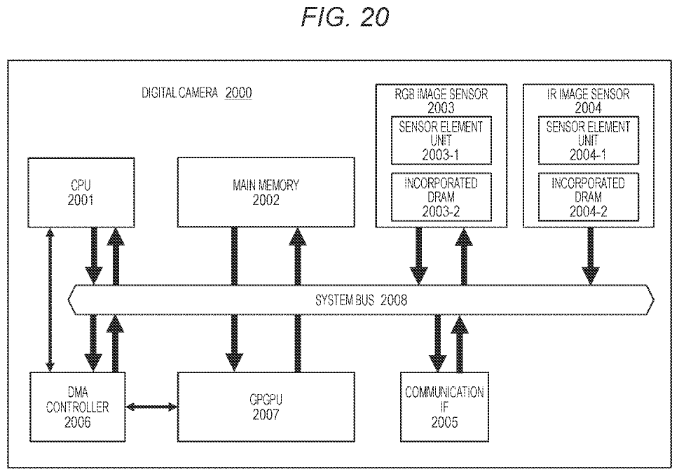

FIG. 20 illustrates an internal configuration example of a digital camera 2000 as another specific example of the second apparatus 1202. The illustrated digital camera 2000 includes a CPU 2001, a main memory 2002, an RGB image sensor 2003, an IR image sensor 2004, a communication interface 2005, a DMA controller 2006, and a GPGPU (or a neural network accelerator) 2007, and each unit is interconnected with each component via a system bus 2008. Note that the digital camera 2000 may include other components, but illustration thereof is omitted in FIG. 20 for simplification of the drawing. Furthermore, the neural network accelerator may be implemented as one processor mounted inside the CPU 201 or the GPGPU 2007.

The CPU 2001 can directly access the main memory 2002. Furthermore, the main memory 2002 can be configured as a virtual storage or a share degree memory together with an extension memory or an external storage device (not illustrated). In this case, the CPU 20091 and the GPGPU 2007 can access other than the main memory via the DMA controller 2006. Furthermore, the external device connected via the communication interface 2005 can access the main memory 2002 by making a DMA request to the DMA controller 2006.

The RGB image sensor 2003 corresponds to a first sensor (or a general-purpose sensor). The RGB image sensor 2003 includes a sensor element unit 2003-1 and an incorporated DRAM 2003-2. The sensor element unit 2003-1 includes a sensor element such as a CCD or a CMOS, and a signal processing circuit that processes a sensor signal. Furthermore, the sensor element unit 2003-1 can perform signal processing of estimating sensor information (second sensor information) sensed by another sensor (second sensor) from original sensor information (first sensor information) obtained from the sensor element unit 2003-1 on the basis of a learned model set in an incorporated DRAM 2003-2.

The IR image sensor 2004 corresponds to a second sensor (or a specialized sensor). The IR image sensor 2004 includes a sensor element unit 2004-1 and an incorporated DRAM 2004-2. The sensor element unit 2004-1 includes a sensor element and a signal processing circuit that processes a sensor signal. Furthermore, the sensor information (second sensor information) after the signal processing is written in the incorporated DRAM 2004-2 and further transferred to the main memory 2002 through the intervention of the DMA controller 2006.

The GPGPU 2007 is a processing unit that can be used for general purposes, but here, it is assumed that a part of an artificial intelligence model generation program (software) is operated by the CPU 2001 and a part specialized for processing of a neural network is operated by the GPGPU 2007, thereby being used for generation processing of a learned model. The learned model here refers to a learned model that estimates other sensor information corresponding to sensor information (first sensor information) sensed by the RGB image sensor 2003. Furthermore, the other sensor information is specifically second sensor information sensed by the IR image sensor 2004 as the second sensor.

In the GPGPU 2007, a pair of the second sensor information sensed by the IR image sensor 2004 as the second sensor and the first sensor information sensed by the RGB image sensor 2003 as the first sensor at the same time is used as learning data, and generation of a learned model for performing processing of estimating second sensor information corresponding to first sensor information is performed. In a case where the artificial intelligence model to be learned is represented by a neural network, the GPGPU 2007 obtains a set of coupling weighting coefficients between learned nodes (neurons) as a result of generating a learned model on the basis of the artificial intelligence model. Then, the GPGPU 2007 stores the generated learned model in the main memory 2002 through the intervention of the DMA controller 2006. The digital camera 2000 is equipped with the IR image sensor 2004 together with the RGB image sensor 2003, and can always acquire learning data necessary for learning. Accordingly, relearning of the learned model can be repeatedly performed in the GPGPU 2007, and a highly accurate learned model can be generated. Note that, since the mechanism for generating the learned model has already been described with reference to FIG. 15, detailed description thereof will be omitted here.

The communication interface 2005 is a functional module that interconnects with a network via a wired or wireless medium. In a case where the communication interface 2005 receives the learned model request from the fourth apparatus 1204, the learned model stored in the main memory 1902 is transferred to the communication interface 2005 through the intervention of the DMA controller 2006, and in the communication interface 2005, return processing of the learned model to the fourth apparatus 1204 of the request source is performed.

### Fourth embodiment

As described in the first to third embodiments, the technology according to the present disclosure can be implemented in various forms. It goes without saying that the embodiments described above are merely examples, and it should be sufficiently understood that the technology according to the present disclosure can be implemented in more forms by combining or partially modifying the forms of two or more embodiments.

Hereinafter, as a fourth embodiment of the technology according to the present disclosure, an embodiment in which a function of a sensor having an optical flow analysis function is a learning target will be described. Note that the optical flow is a vector representing the motion of an object in an image.

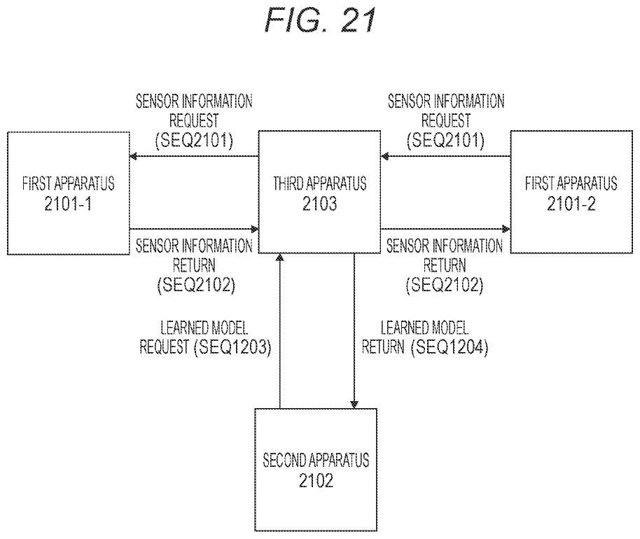

FIG. 21 schematically illustrates an operation sequence example of an artificial intelligence sensor system according to the fourth embodiment. The illustrated artificial intelligence sensor system includes first apparatuses 2101-1 and 2101-2, a second apparatus 2102, and a third apparatus 2103, and each apparatus corresponds to an apparatus having the same name in FIG. 2 referred to in the description of the first embodiment (basically, the first apparatuses 2101-1 and 2101-2 have the apparatus configuration illustrated in FIG. 3, the second apparatus 2102 has the apparatus configuration illustrated in FIG. 5, and the third apparatus 2103 has the apparatus configuration illustrated in FIG. 4). However, in FIG. 21, in order to clarify the effect brought about by the fourth embodiment, the first apparatus 201 in FIG. 2 is separately illustrated as the first apparatus 2101-1 that provides first sensor information as learning data and the first apparatus 2101-2 that provides second sensor information as training data. Furthermore, the third apparatus 2103 generates a learned model on the basis of the first sensor information and the second sensor information provided from the first apparatuses 2101-1 and 2101-2, and a result of a service using the learned model is provided from the third apparatus 2103 to the second apparatus 2102, which is similar to the first embodiment.

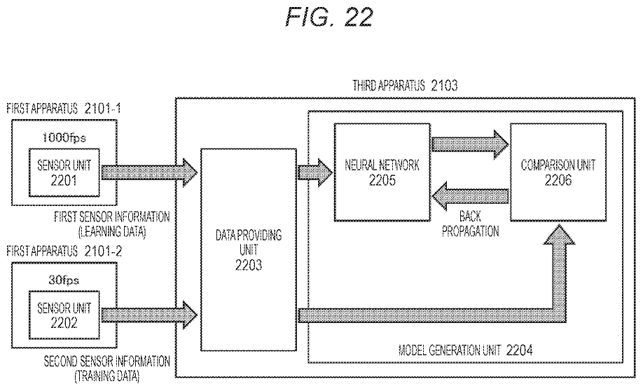

FIG. 22 illustrates a mechanism in which the third apparatus 2103 acquires sensor information from two first apparatuses 2101-1 and 2101-2 and generates a learned model.

The first apparatus 2101-1 includes an image sensor as the sensor unit 2201, and supplies an RGB output of 1000 frame per second (fps) of the sensor unit 2201 to the third apparatus 2103 as first sensor information (learning data). Furthermore, the sensor unit 2202 of the first apparatus 2101-2 is equipped with an image sensor and an image analysis processor. The image analysis processor reads the output of the image sensor at 30 fps, calculates an optical flow, and supplies the optical flow to the third apparatus 2103 as second sensor information (training data). The calculation of the optical flow can be implemented by using a block matching method, a gradient method, a Lucas-Kanade (LK) method, or the like, and can be implemented as a computer program operating on a hardware circuit or a processor.

The second apparatus 2103 includes, in the data providing unit 2203, a communication module (not illustrated) having a wireless or wired communication function, a storage device (not illustrated) having a memory function of accumulating data, and a control device (not illustrated) as a memory controller that reads and writes data from and to the storage device, so that the first sensor information from the first apparatus 2101-1 and the second sensor information from the first apparatus 2101-2 can be received by communication and stored in the storage device, and the first sensor information and the second sensor information can be provided to the model generation unit 2204 in synchronization with each other. Specifically, the data providing unit 2203 is configured to read the first sensor information and the second sensor information from the storage device through the control device at a predetermined timing by operating a computer program read from the storage device on a processor (not illustrated) such as a CPU. In the present embodiment, the data providing unit 2203 acquires new first sensor information from the first apparatus 2101-1 at the timing of 1000 fps, and newly acquires second sensor information from the first apparatus 2101-2 at the timing of 30 fps. There are at least the following two methods for synchronizing the first sensor information and the second sensor information.

(1) A method of synchronizing at a reception timing of a data frame of first sensor information at a higher frame rate: since data is read at a timing of 1000 fps that is the frame rate of the first sensor information, for second sensor information other than the second sensor information received at the timing, the second sensor information that has been received immediately before and written in the storage device is repeatedly read.

(2) A method of synchronizing at a reception timing of a data frame of second sensor information at a lower frame rate: since data is read at a timing of 30 fps that is a frame rate of the second sensor information, the first sensor information received at the timing is read as it is, and the first sensor information received at other timings is not read.

The third apparatus 2103 further includes a model generation unit 2204. The model generation unit 2204 includes a neural network 2205 as artificial intelligence. The data providing unit 2203 performs learning of the artificial intelligence by inputting the first sensor information and the second sensor information to the neural network 2205 in synchronization with one of the methods. As a result, the neural network 2205 including a coupling weighting coefficient between nodes (neurons) is generated as a learned model capable of performing processing of estimating second sensor information corresponding to first sensor information.

Furthermore, the model generation unit 2204 further includes a comparison unit 2206 that compares the output of the neural network 2205 with the second sensor information as training data. The comparison unit 2206 compares the second sensor information estimated by the neural network 2205 with the second sensor information as the training data input via the data providing unit 2203. Then, a loss function based on a difference between the second sensor information estimated by the neural network 2205 and the training data is defined, and learning of the neural network 2205 is performed by back propagation so as to minimize the loss function. A learned model having a set of coupling weighting coefficients between nodes (neurons) in the neural network 2205 when the loss function is minimized is stored in a model accumulation unit (not illustrated) in the third apparatus 2103.

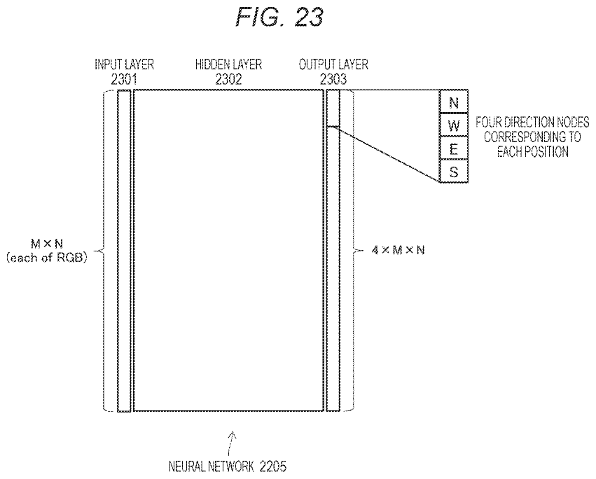

FIG. 23 illustrates an example of the neural network 2205. The neural network 2205 includes an input layer 2301, a hidden layer 2302, and an output layer 2303. Here, the pixel size of the image sensor is set to M×N, and data of all pixels is input in the input layer 2301. All RGB data may be input to one neural network, or the input layer of the neural network may be separately provided for R, G, and B. The output layer 2303 is configured such that, for each pixel, four direction components in which directions of optical flows are north (N), west (W), east (E), and south (S) are output as a set. As another configuration example of the output layer 2303, one real value is output as a real value of the angle component of the optical flow for each pixel. For example, east (E) is 0.0, north (N) is 90.0, west (W) is 180.0, and south (S) is 270.0, and any value therebetween is output as a real value of the angle component.

The data format of the first sensor information output from the first apparatus 2101-1 may be different from the data format of the second sensor information output from the first apparatus 2101-2. In this case, it is sufficient that the data providing unit 2203 converts the data format of the first sensor information and the second sensor information into the same data format as the output data of the output layer 2303 of the neural network 2205 and the output data of the comparison unit 2206 by operating a computer program read from the storage device on a processor (not illustrated) such as a CPU.

With the above configuration, even in a case where the second apparatus 2102 including the same sensor unit 2201 as that of the first apparatus 2101-1 is not equipped with the optical flow function, the function of the optical flow can be provided (specifically, a function of estimating optical flow data from image sensor data can be provided) by requesting the neural network 2205, which is a learned model, from the third apparatus 2103 by a computer program (application) operating on a processor (not illustrated) in the second apparatus 2102 and downloading and using the learned model returned from the third apparatus 2103.

Moreover, in the present embodiment, an apparatus capable of processing data of a higher frame rate can acquire a function of an apparatus that performs optical flow analysis at a lower speed and a fixed frame rate by learning of artificial intelligence. In this case, in a case where the estimation result of the learned model hardly changes, the application operating on the second apparatus 2102 does not output an estimation result or outputs data suggesting that the estimation result may be ignored, and thereby, there is an effect that it is possible to generate an artificial intelligence model that enables learning using the sensor information for generating the sensor output at the fixed frame rate and the sensor information for generating the sensor output at the higher frame rate to calculate the optical flow at the variable frame rate, by utilizing the technology according to the present disclosure.

### Fifth Embodiment

As an application example of the artificial intelligence sensor system according to the first to fourth embodiments, a scalable camera system can be constructed using a general-purpose camera.

For example, each of 10 cameras is initially installed as a first apparatus in a stadium, and a third apparatus grasps a position of an object (a player, a musician, or the like) in a field of view of each camera and generates a learned model that changes the field of view by zoom processing (zoom in, zoom out) at an appropriate timing.

Thereafter, in a case where additional cameras are installed, these additional cameras can learn an output pattern of an image of an existing camera by artificial intelligence. In this case, the second apparatus that is the additional camera can request the third apparatus that is the artificial intelligence server to learn the neural network so as to output a similar output using the sensor information of the first apparatus that is the camera already installed at a position relatively close to the second apparatus, and can cause the third apparatus to generate the learned model.

By downloading the learned model generated in this manner to the second apparatus that is an additional camera, it is possible to construct a camera system in which the camera can be added in a scalable manner without performing the entire learning again together with the camera installed from the beginning.

As in the third embodiment, in a case where the second apparatus as the additional camera has a learning function, learning can be performed without using the third apparatus as the artificial intelligence server, and a learned model can be generated. On the other hand, moreover, the generated learned model can be uploaded to the fourth apparatus as the artificial intelligence server for a case where the additional camera is installed in proximity.

### INDUSTRIAL APPLICABILITY

The technology according to the present disclosure has been described in detail with reference to specific embodiments. However, it is obvious that those skilled in the art can make modifications and substitutions of the embodiments without departing from the gist of the technology according to the present disclosure.

The technology according to the present disclosure can be applied to processing of estimating other sensor information corresponding to one sensor information in various combinations of sensors. In the present specification, an embodiment related to a combination of an RGB camera and a sensor that captures two-dimensional information, such as an IR camera and a distance sensor, has been mainly described, but the present invention is not limited thereto. For example, the technology according to the present disclosure can be applied to processing of estimating audio, temperature, vibration, wind, neuromorphic perception event, or the like from two-dimensional information such as images of natural scenes.

In short, the technology according to the present disclosure has been described in the form of exemplification, and the contents of the description of the present specification should not be interpreted restrictively. In order to determine the gist of the technology according to the present disclosure, the scope of claims should be taken into consideration.

Note that the technology disclosed in the present specification may have the following configuration.

(1) An information processing apparatus including:

a collection unit that collects first sensor information detected by a first sensor and second sensor information detected by a second sensor;

a model generation unit that generates a learned model for estimating second sensor information corresponding to first sensor information on the basis of the first sensor information and the second sensor information that have been collected;

an accumulation unit that accumulates the learned model; and

a providing unit that provides a result of a service based on the learned model.

(2) The information processing apparatus according to (1),

in which the collection unit requests sensor information from a first apparatus including the first sensor or the second sensor, and collects the first sensor information or the second sensor information returned from the first apparatus.

(3) The information processing apparatus according to (1) or (2),

in which the model generation unit generates a learned model for each combination of the first sensor and the second sensor,

the accumulation unit accumulates one or more of the learned model generated for each combination of the first sensor and the second sensor, and

the providing unit selectively reads a learned model corresponding to a request from a second apparatus from the accumulation unit and provides a result of a service based on the learned model.

(4) The information processing apparatus according to any one of (1) to (3),

in which the providing unit provides the result of the service based on the learned model in response to the request from the second apparatus.

(5) The information processing apparatus according to any one of (1) to (4),

in which the providing unit provides the learned model to the second apparatus as the result of the service.

(6) The information processing apparatus according to any one of (1) to (4),

in which the providing unit estimates second sensor information corresponding to first sensor information transmitted from the second apparatus by using the learned model, and returns the second sensor information that has been estimated, as the result of the service.

(7) An information processing method including:

a collection step of collecting first sensor information detected by a first sensor and second sensor information detected by a second sensor;

a model generation step of generating a learned model for estimating second sensor information corresponding to first sensor information on the basis of the first sensor information and the second sensor information that have been collected;

an accumulation step of accumulating the learned model in an accumulation unit; and

a providing step of providing a result of a service based on the learned model.

(8) An information processing apparatus including:

a first sensor that detects first sensor information; and

an input unit that inputs, from a third apparatus, a result of a service based on a learned model for estimating second sensor information corresponding to first sensor information.

(9) The information processing apparatus according to (8), further including

a request unit that requests the result of the service from the third apparatus,

in which the input unit inputs the result of the service returned from the third apparatus in response to a request.

(10) The information processing apparatus according to (8) or (9),

in which the second sensor information corresponding to first sensor information detected by the first sensor is used on the basis of an input of the result of the service.

(11) The information processing apparatus according to any one of (8) to (10),

in which the input unit inputs, from the third apparatus, the learned model for estimating the second sensor information corresponding to first sensor information as the result of the service, and

the information processing apparatus further includes an estimation unit that estimates the second sensor information corresponding to first sensor information detected by the first sensor using the learned model that has been input.

(12) The information processing apparatus according to any one of (8) to (10),

in which the request unit transmits the first sensor information detected by the first sensor to the third apparatus, and

the input unit inputs as the result of the service, from the third apparatus, the second sensor information corresponding to first sensor information that has been transmitted, the second sensor information estimated using the learned model.

(13) An information processing method including steps of:

acquiring first sensor information from a first sensor;

requesting from a third apparatus a result of a service based on a learned model for estimating second sensor information corresponding to first sensor information; and

inputting the result of the service from the third apparatus.

(14) An information processing apparatus including:

a first sensor;

a collection unit that collects second sensor information detected by a second sensor; and

a model generation unit that generates a learned model for estimating the second sensor information corresponding to first sensor information on the basis of the first sensor information detected by the first sensor and the second sensor information collected by the collection unit.

(15) The information processing apparatus according to (14), further including

an estimation unit that estimates the second sensor information corresponding to first sensor information detected by the first sensor by using the learned model generated by the model generation unit.

(16) The information processing apparatus according to (14) or (15), further including

a providing unit that provides a fourth apparatus with a result of a service based on the learned model.

(17) The information processing apparatus according to (16),

in which the providing unit transmits the learned model generated by the model generation unit to the fourth apparatus as the result of the service.

(18) An information processing method including:

a collection step of collecting second sensor information detected by a second sensor by an information processing apparatus; and

a model generation step of generating a learned model for estimating second sensor information corresponding to first sensor information on the basis of the first sensor information detected by the first sensor in the information processing apparatus and the second sensor information collected in the collection step.

### REFERENCE SIGNS LIST

201 First apparatus
202 Second apparatus
203 Third apparatus
301 Sensor unit
302 Processing unit
303 Output unit
304 Environment information acquisition unit
305 Device information acquisition unit
306 Sensor information storage unit
307 Request input unit
308 Sensor information output unit
401 Data collection unit
402 Sensor information accumulation unit
403 Model generation unit
404 Sensor information reading unit
405 Model accumulation unit
406 Request input unit
407 Model output unit
501 Neural network
502 Comparison unit
601 Sensor unit
602 Processing unit
603 Output unit
604 Estimation part
605 Second processing unit
606 Second output unit
607 Request output unit
608 Learned model input unit
609 Control unit
701 First apparatus
702 Second apparatus
703 Third apparatus
801 Data collection unit
802 Sensor information accumulation unit
803 Model generation unit
804 Sensor information reading unit
805 Model accumulation unit
806 Estimation part
807 Request input unit
808 Estimation result output unit
901 Sensor unit 901
902 Processing unit 902
903 Output unit
904 Request output unit
905 Estimation result input unit
906 Control unit
907 Second processing unit
908 Second output unit
1401 Sensor unit
1402 Processing unit
1403 Output unit
1404 Data collection unit
1405 Model generation unit
1406 Model accumulation unit
1407 Estimation part
1408 Second processing unit
1409 Second output unit
1410 Control unit
1411 Learned model providing unit
1501 Neural network
1502 Comparison unit
1900 Digital camera
1901 CPU
1902 Main memory
1903 RGB image sensor
1904 Communication interface
1905 DMA controller
1906 GPGPU
1907 System bus
2000 Digital camera
2001 CPU
2002 Main memory
2003 RGB image sensor
2004 IR image sensor
2005 Communication interface
2006 DMA controller
2007 GPGPU
2008 System bus
2101-1, 2101-2 First apparatus
2102 Second apparatus
2103 Third apparatus
2201 Sensor unit (image sensor)
2202 Sensor unit (image sensor and image analysis processor)
2203 Data providing unit
2204 Model generation unit
2205 Neural network
2206 Comparison unit

1. An information processing apparatus comprising:
a collection unit that collects first sensor information detected by a first sensor and second sensor information detected by a second sensor;
a model generation unit that generates a learned model for estimating second sensor information corresponding to first sensor information on a basis of the first sensor information and the second sensor information that have been collected;
an accumulation unit that accumulates the learned model; and
a providing unit that provides a result of a service based on the learned model.

2. The information processing apparatus according to claim 1,
wherein the collection unit requests sensor information from a first apparatus including the first sensor or the second sensor, and collects the first sensor information or the second sensor information returned from the first apparatus.

3. The information processing apparatus according to claim 1,
wherein the model generation unit generates the learned model for each combination of the first sensor and the second sensor,
the accumulation unit accumulates one or more of the learned model generated for each combination of the first sensor and the second sensor, and
the providing unit selectively reads a learned model corresponding to a request from a second apparatus from the accumulation unit and provides a result of a service based on the learned model.

4. The information processing apparatus according to claim 1,
wherein the providing unit provides the result of the service based on the learned model in response to a request from a second apparatus.

5. The information processing apparatus according to claim 1,
wherein the providing unit provides the learned model to a second apparatus as the result of the service.

6. The information processing apparatus according to claim 1,
wherein the providing unit estimates second sensor information corresponding to first sensor information transmitted from the second apparatus by using the learned model, and returns the second sensor information that has been estimated, as the result of the service.

7. An information processing method comprising:
a collection step of collecting first sensor information detected by a first sensor and second sensor information detected by a second sensor;
a model generation step of generating a learned model for estimating second sensor information corresponding to first sensor information on a basis of the first sensor information and the second sensor information that have been collected;
an accumulation step of accumulating the learned model in an accumulation unit; and
a providing step of providing a result of a service based on the learned model.

8. An information processing apparatus comprising:
a first sensor that detects first sensor information; and
an input unit that inputs, from a third apparatus, a result of a service based on a learned model for estimating second sensor information corresponding to first sensor information.

9. The information processing apparatus according to claim 8, further comprising
a request unit that requests the result of the service from the third apparatus,
wherein the input unit inputs the result of the service returned from the third apparatus in response to a request.

10. The information processing apparatus according to claim 8,
wherein the second sensor information corresponding to first sensor information detected by the first sensor is used on a basis of an input of the result of the service.

11. The information processing apparatus according to claim 8,
wherein the input unit inputs, from the third apparatus, the learned model for estimating the second sensor information corresponding to first sensor information as the result of the service, and
the information processing apparatus further comprises an estimation unit that estimates the second sensor information corresponding to first sensor information detected by the first sensor using the learned model that has been input.

12. The information processing apparatus according to claim 8,
wherein the request unit transmits the first sensor information detected by the first sensor to the third apparatus, and
the input unit inputs as the result of the service, from the third apparatus, the second sensor information corresponding to first sensor information that has been transmitted, the second sensor information estimated using the learned model.

13. An information processing method comprising steps of:
acquiring first sensor information from a first sensor;
requesting from a third apparatus a result of a service based on a learned model for estimating second sensor information corresponding to first sensor information; and
inputting the result of the service from the third apparatus.

14. An information processing apparatus comprising:
a first sensor;
a collection unit that collects second sensor information detected by a second sensor; and
a model generation unit that generates a learned model for estimating the second sensor information corresponding to first sensor information on a basis of the first sensor information detected by the first sensor and the second sensor information collected by the collection unit.

15. The information processing apparatus according to claim 14, further comprising
an estimation unit that estimates the second sensor information corresponding to first sensor information detected by the first sensor by using the learned model generated by the model generation unit.

16. The information processing apparatus according to claim 14, further comprising
a providing unit that provides a fourth apparatus with a result of a service based on the learned model.

17. The information processing apparatus according to claim 16,
wherein the providing unit transmits the learned model generated by the model generation unit to the fourth apparatus as the result of the service.

18. An information processing method comprising:
a collection step of collecting second sensor information detected by a second sensor by an information processing apparatus; and
a model generation step of generating a learned model for estimating second sensor information corresponding to first sensor information on a basis of the first sensor information detected by the first sensor in the information processing apparatus and the second sensor information collected in the collection step.
